(19) United States
(12) Patent Application Publication
(10) Pub. No.: US 2018/0213838 A1
(43) Pub. Date: Aug. 2, 2018

(54) COMPACT SYSTEM FOR PREPARING PERSONAL SMOKABLE PRODUCTS

(71) Applicant: BANANA BROS LLC, Culver City, CA (US)

(72) Inventors: David Richmond, Culver City, CA (US); Howard Richmond, Los Angeles, CA (US); Manuel A. Montano, Gardena, CA (US); Jeffery Kunkler, Culver City, CA (US)

(73) Assignee: BANANA BROS LLC, Culver City, CA (US)

(21) Appl. No.: 15/690,141

(22) Filed: Aug. 29, 2017

Related U.S. Application Data
(63) Continuation-in-part of application No. 15/447,069, filed on Mar. 1, 2017, now Pat. No. 9,814,259.
(60) Provisional application No. 62/450,535, filed on Jan. 25, 2017.

(51) Int. Cl. A24C 5/42; A24C 5/06; A24B 7/04; A24B 7/14; B02C 18/16

(52) U.S. Cl. CPC A24C 5/42; A24C 5/06; B02C 18/16; A24B 7/14; A24B 7/04

(57) ABSTRACT

A system for preparing smokeable material comprising a wall providing an upper chamber and a lower chamber with a grate between the chambers. Feed smokeable material in the upper chamber has its size reduced with a size reducer a sufficient amount such that it can pass through the grate into the lower chamber as fill smokeable material. There is an opening in the lower chamber for fill smokeable material to pass out of the lower chamber. The fill smokeable material can then be used to fill a wrapper or a smokeable device.

### CROSS REFERENCE

The present Application claims the benefit of U.S. Provisional Patent Application No. 62/450,535 titled “Compact System for Preparing Personal Smokeable Products,” filed Jan. 25, 2017, U.S. Provisional Patent Application 62/536,415 titled “Compact System for Preparing Personal Smokeable Products” filed Jul. 24, 2017, and is a Continuation-in-Part of U.S. patent application Ser. No. 15/447,069 titled “Compact System for Preparing Personal Smokeable Products” filed Mar. 1, 2017, the contents of all of which are incorporated in this disclosure by reference in their entirety.

### BACKGROUND

Products for preparing cigarettes and other smokeable products are known. For example, see: WO02056714A1, DK177367B, DE3427480A1, GB2124882, and EP1374705A1.

A problem with many existing products is that they are unable to quickly and easily prepare fill smokeable material starting with gross sized feed material. It is desirable that there be a portable, easy to use device that can produce a fill smokeable material in a short a period of time.

### SUMMARY

This invention provides a system, including an apparatus and a method that satisfies this need. The apparatus can be portable and hand holdable. The apparatus comprises an enclosing wall providing an upper chamber and a lower chamber, with a grate between the chambers. A fill inlet can be used for placing feed smokeable material into the upper chamber. There can be a door secured to the wall for covering the fill inlet, the door having a closed position for substantially closing the fill inlet and an open position for opening the fill inlet for placement of feed smokeable material into the upper chamber. The door can be biased to the closed position, and can be optionally locked in the closed position. In one embodiment, the door can be slidable along the wall.

A cutting mechanism, such as a rotatable size reducer, located in the upper chamber, allows for reducing the size of feed smokeable material in the upper chamber a sufficient amount that size reduced smokeable material can pass through the grate into the lower chamber. An opening in the lower chamber allows for fill smokeable material to pass into a wrapper or other smoking device to make a smokeable product.

The size reducer can be manual or powered. A motor can power rotation of the size reducer, and a power source such as a battery or external power source can driving the motor. There can be a switch for turning the power source off and on. The switch can provide variable speeds, have fixed different speed positions, or be an on-off switch for a constant speed motor. The switch is preferably located on the outside of the wall.

The size reducer can be a rotatable blade, or a grinder comprising a rotatable grinding plate, also referred to as a comminution plate, with a grinder having first grinding projections, and a grinding surface, also referred to as a comminution plate, having second grinding projections opposed to the first grinding projections for grinding smokeable material between the first and second grinding projections. The grinder can rotate both clockwise and counterclockwise. The apparatus can have a biasing means, such as a spring, for biasing the grinder toward the grinding surface. The spring can move the grinder and the grinding surface toward each other as ground smokeable material is discharged through the opening. The spring can provide 1 to 5 pounds of force.

To prevent clogging and accumulation of smokeable material around a central projection, it is desirable that one or more projections having cutting blades on their side surface. Thus, the invention can include a device for comminuting smokeable material comprising a first rotatable comminution plate having a rotational axis with a plurality of first projections extending from the plate, each of the first projections having a base proximate to the first plate and a side surface, one of the first projections being an axial projection at the rotational axis. The device includes a second comminution plate opposed to the first plate, the second plate having a plurality of second projections, the first and second projections oriented so that during a comminution operation when the first plate is rotated about the rotational axis, the first and second projections cooperate to comminute smokeable material. There are a plurality of cutting blades extending from the side surface of the axial projection. The cutting blades can extend at an angle of from about 80 degrees to about 10 degrees, and preferably 30 degrees away from the base of the axial projection relative to the plane of the side surface of the axial projection. A central projection of the second projection can also have a plurality of cutting blades extending from its side surface.

The size reducer can be moveable, with a first position distal from the grate and a second position closer to the grate. The moveable size reducer can contain biasing means for biasing the size reducer to the second position.

There can optionally be an elongated storage space supported by the wall. The storage space can house a removable tamper in the storage space for tamping fill smokeable material in the wrapper.

The apparatus can also contain a mover in the lower chamber for moving fill smokeable material out of the opening. The mover is rotatable and can contain a shaft is adapted to rotate the mover. The mover can be paddle-shaped.

The apparatus can contain a controller coupled to the motor that can be adapted for automatically controlling the motor to rotate in a clockwise or counterclockwise direction for rotating the grinder in a clockwise or counterclockwise direction. The controller can automatically turn off the motor after the grinder has rotated for a predetermined amount of time, such as, for example about 3 to about 10 seconds. Alternatively, the controller can be adapted to automatically reverse the direction of rotation of the grinder within 5 seconds, after 0.5 to 3 seconds, preferably within one second after the motor is turned on. Optionally, the controller can be adapted to automatically reverse the direction of rotation of the grinder at least twice. In one embodiment, the controller can be adapted to automatically reverse the grinder after the grinder has rotated for 1 to 20 rotations. Alternatively, the controller can be adapted to automatically reverse the motor if the amperage of the motor when the amperage exceeds a predetermined amount, such as between 65 to 90 percent, or more than 90 percent of a predetermined amperage.

To use, a user places feed smokeable material into the upper chamber. The size reducer is activated to reducing the size of the feed smokeable material, so at least a portion of the feed smokeable material falls through the grate as fill smokeable material into the lower chamber. The fill smokeable material is optionally used to fill a wrapper.

There are many advantages to the present invention, not all of which need to be present in every version of the invention. Exemplary of the advantages are that the system can:

1. be portable;

2. be hand holdable;

3. produce a smokeable product from feed material within as few as 10 seconds;

4. be inexpensive;

5. be compact;

6. be used with conventional, commercially available wrappers;

7. with the tamping feature, allow the user to a desired amount of compression and fill; and

8. for users without sufficient wrist strength or a handicap, powered (with or without being mechanically usable).

### DRAWINGS

These and other features, aspects, and advantages of the present invention will become better understood with regard to the following description, appended claims, and accompanying drawings where:

FIG. 1 is a perspective view of a first apparatus having features of the present invention;

FIG. 2 is a front elevation view of the apparatus of FIG. 1;

FIG. 3 is a side elevation view of the apparatus of FIG. 1;

FIG. 4 is a longitudinal sectional view of the apparatus of FIG. 1 taken on line 4-4 in FIG. 1;

FIG. 5 is a perspective view of one embodiment of a grate useful with the first apparatus;

FIG. 6 is a perspective view of a second apparatus having features of the present invention;

FIG. 7 is a front elevation view of the apparatus of FIG. 6;

FIG. 8 is a side elevation view of the apparatus of FIG. 6 taken on line 8-8 in FIG. 6;

FIG. 9 is a longitudinal sectional view of the apparatus of FIG. 6 taken on line 9-9 in FIG. 6;

FIG. 10 is a perspective view of a third apparatus having features of the present invention;

FIG. 11 is a front elevation view of the apparatus of FIG. 10;

FIG. 12 is an exploded front elevation view of the apparatus of FIG. 10;

FIGS. 13-15 are partial longitudinal sectional views of the device of FIG. 10 taken on line 13-13 in FIG. 10 showing the positions of the device during its use;

FIG. 16 is a perspective view of a fourth apparatus having features of the present invention;

FIG. 17 is a front elevation view of the apparatus of FIG. 16;

FIG. 18 is an exploded form elevation view of the apparatus of FIG. 16;

FIGS. 19-21 are partial longitudinal sectional views of the device of FIG. 16 taken on line 19-19 in FIG. 16 showing the positions of the device during its use;

FIG. 22 is a perspective view of a fifth apparatus having features of the present invention;

FIG. 23 is a front elevation view of the apparatus of FIG. 22,

FIG. 24 is a side elevation view of the apparatus of FIG. 22;

FIG. 25 is an exploded front elevation view of the apparatus of FIG. 22;

FIG. 26 is a partial longitudinal sectional view of the apparatus of FIG. 22 taken on line 26-26 in FIG. 22.

FIG. 27 is a partially broken away perspective view of the apparatus of FIG. 22 in the second position;

FIG. 28 is a partially broken away perspective view of the apparatus of FIG. 22 in the first position;

FIG. 29 is a side elevation view of an embodiment of a size reducer and mover useful in this invention in a first position;

FIG. 30 is a side elevation view of an embodiment of the size reducer and mover of FIG. 29 in a second position;

FIG. 31 is a perspective view of a sixth apparatus having features of the present invention;

FIG. 32 is a front elevation view of the apparatus of FIG. 31;

FIGS. 33 and 34 are a longitudinal sectional views of the apparatus of FIG. 31 in a first position and second position, respectively, taken on line 33-33 in FIG. 32;

FIGS. 35A, 35B, and 35C depict a flow chart for a control system for use with the present invention;

FIGS. 36A, 36B, 36C, 36D, and 36E are a schematic diagram of electronic components useful with the apparatus of FIGS. 6, 16, 22 and 31; and

FIGS. 37A and 37B are perspective views of a preferred comminution plate for use in the invention.

### DESCRIPTION

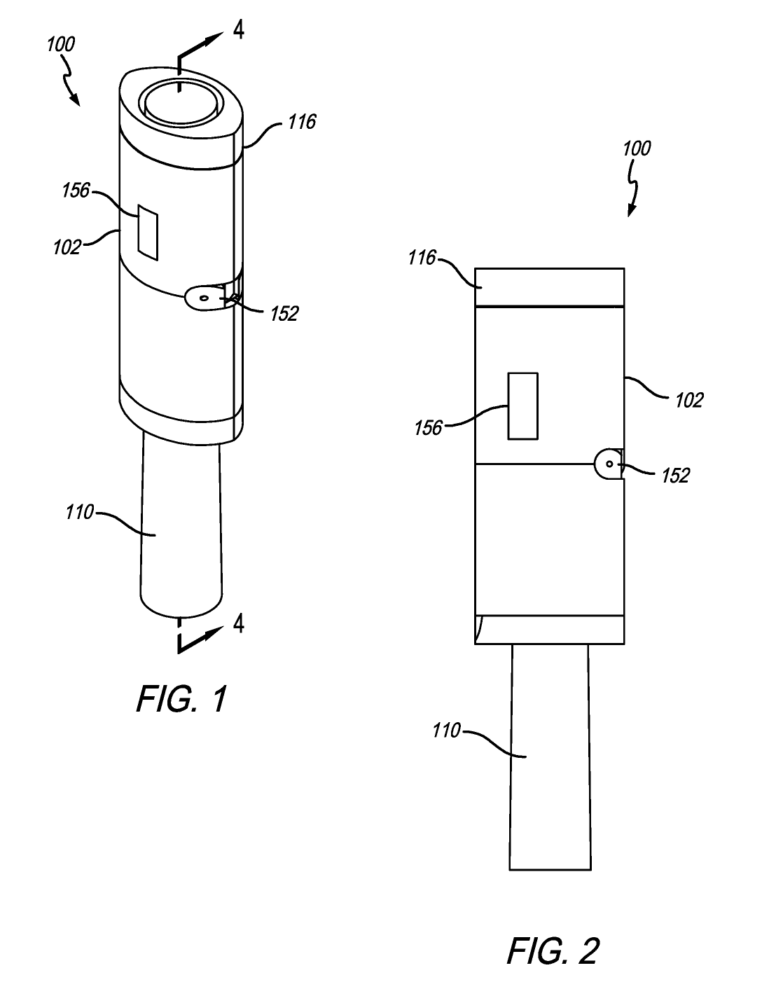

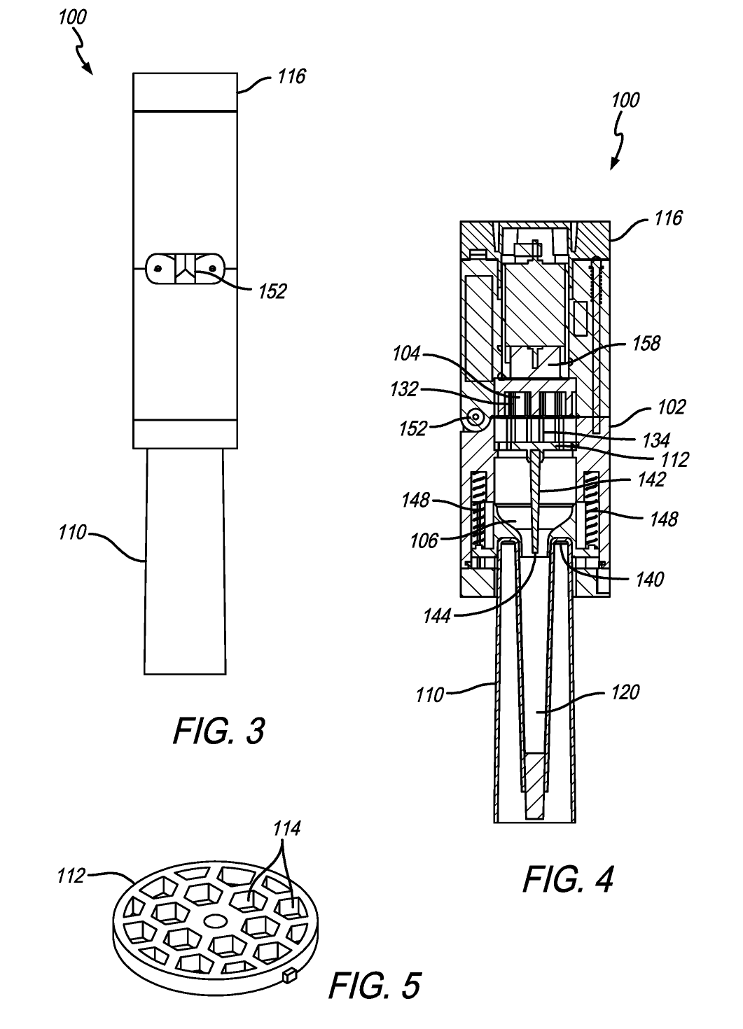

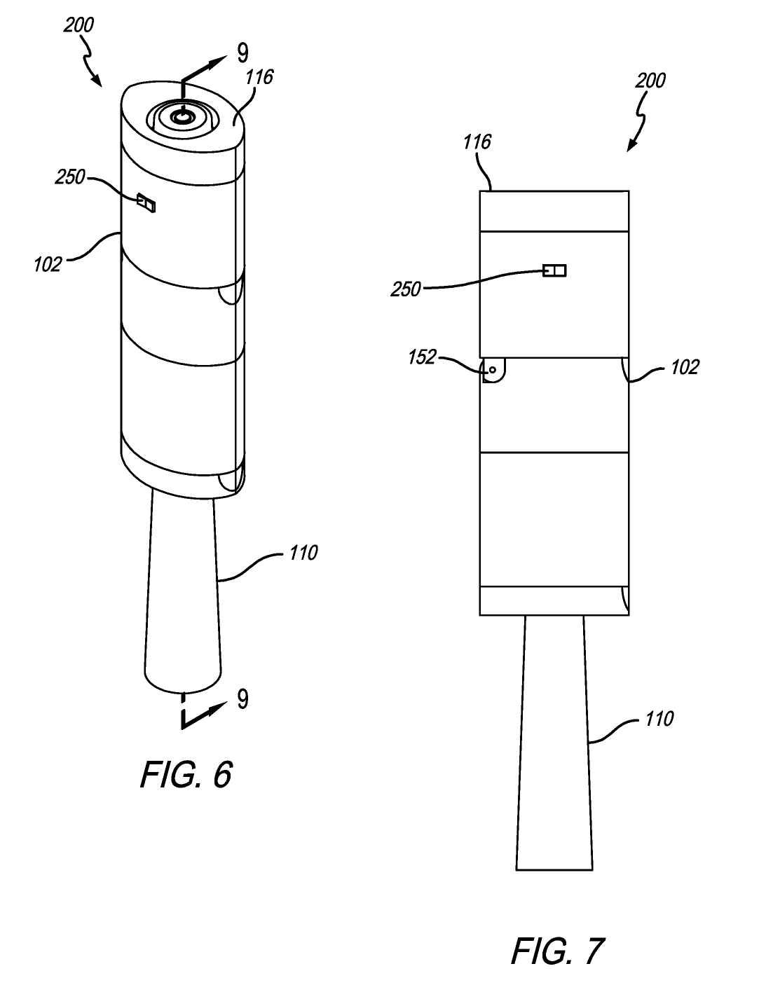

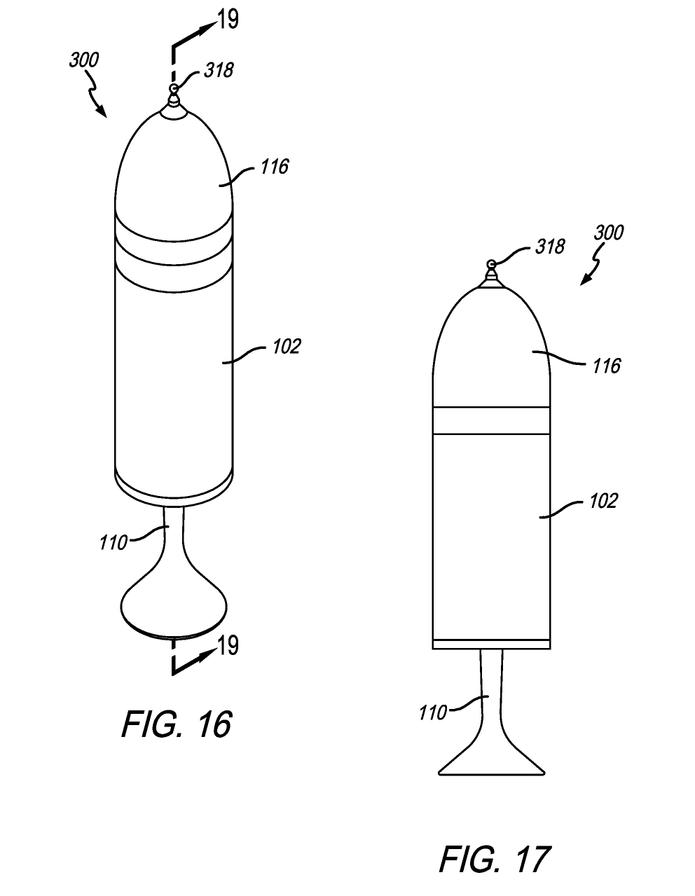

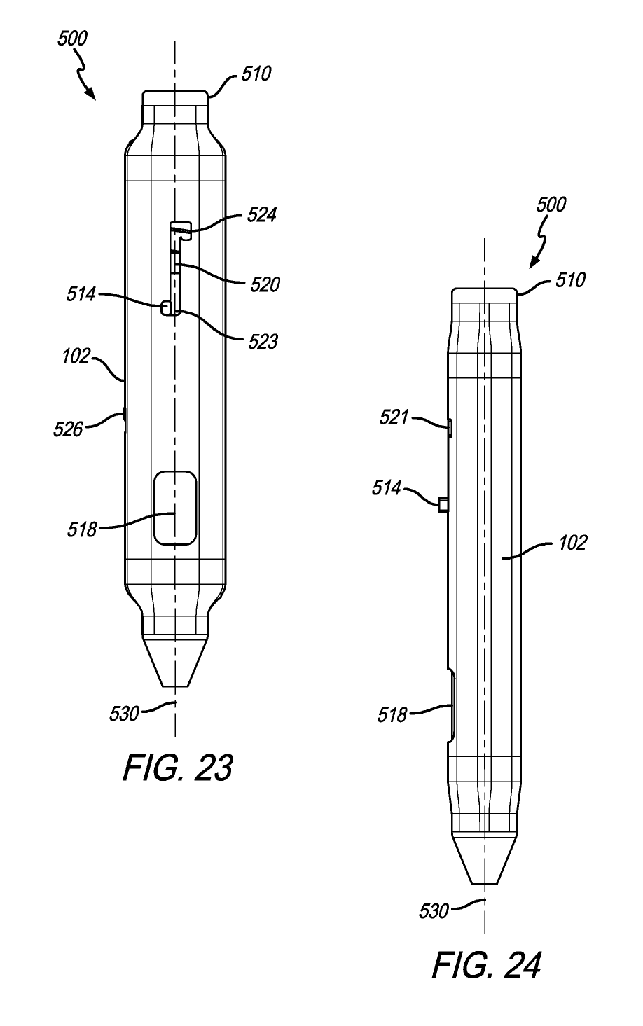

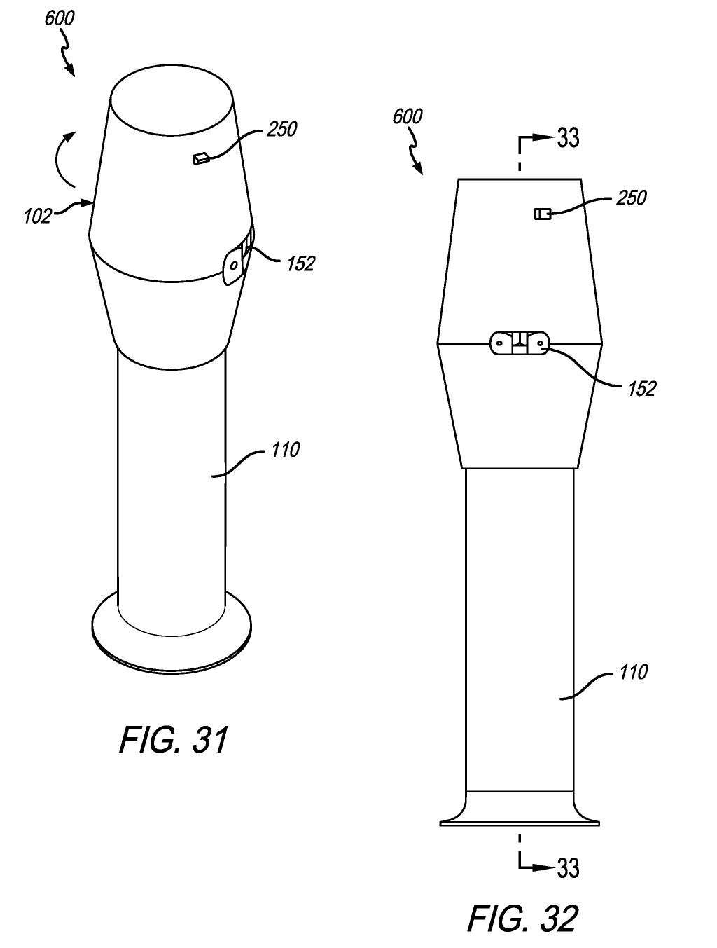

With regard to FIGS. 1 to 37, an apparatus 100, 200, 300, 400, 500, 600 according to the present invention can comprise, as its main elements, a wall 102, and within the wall 102 an upper chamber 104 and a lower chamber 106, a grate 112 between the chambers, a fill inlet 156 for placing feed smokeable material into the upper chamber 104, a rotatable size reducer 230 in the upper chamber 104 for reducing the size of feed smokeable material in the upper chamber 104, and a drive 236 for rotating the rotatable size reducer 230. The apparatus optionally contains a support 110 below the lower chamber 106 for supporting a wrapper 120 below the lower chamber 106, an opening in the lower chamber 106 for fill smokeable material to pass into the wrapper 120 supported by the support 110, and a tamper 142 for tamping fill smokeable material in the wrapper 120.

As used herein, the following terms and variations thereof have the meanings given below, unless a different meaning is clearly intended by the context in which such term is used.

The terms “a,” “an,” and “the” and similar referents used herein are to be construed to cover both the singular and the plural unless their usage in context indicates otherwise.

As used herein, the term “comprise” and variations of the term, such as “comprising” and “comprises,” are not intended to exclude other additives, components, integers or steps.

As used herein, a “controller” is something that directs or regulates something, such as, for example, a rotatable size reducer. A controller can be used in connection with software that directs the controller's function. A controller can include memory such as a random access memory chip. A controller can be a microcontroller (or MCU for microcontroller unit) that contains one or more CPU cores, and may include memory and programmable input/output peripherals or a similar programmable controller on a single integrated circuit, including a system on a chip or SoC, or state machine.

As used herein, “smokeable material” can be any material that is able to be smoked such as, for example, tobacco, marijuana, herbs, or a medicinal substance. The smokeable material can be pure, or it can contain material such as stems or seeds that can be smoked even if not removed, and additives such as flavorants. However, it is contemplated that the device of the invention can be used with material other than smokeable material.

“Feed” smokeable material refers to starting smokeable material. Feed smokeable material can contain a large portion of smokeable material, as well as seeds and stems. As examples, the feed material can be tobacco or marijuana.

It is also contemplated that starting material can be any material that is able to be reduced, or comminuted, in size.

As used herein, smokeable material that is cut or sized to pass through the grate is referred to as “fill” smokeable material. The fill smokeable material is cut by a size reducer a sufficient amount such that the cut smokeable material can pass through the grate into the lower chamber. However, it is possible that the feed smokeable material can be correctly sized to pass through the grate without being cut by the size reducer.

The term “fill inlet” as used herein is an inlet into the upper chamber of an apparatus according to this invention used to place feed smokeable material into the upper chamber. The fill inlet can be an opening in the wall of the upper chamber. Optionally, the opening has a door.

A “grate” contains holes such that the fill smokeable material can pass through the holes into the lower chamber. The grate can be removable. The grate can be made from metal, plastic, or the like.

A “smokeable product” is the wrapper containing fill smokeable material. The smokeable product can be, for example, a tobacco cigarette, a marijuana cigarette, or a cannabis cigarette.

The term “wrapper” as used herein refers to a paper or other combustible material such as tobacco leaf such as is used for cigars. Preferably, the wrapper is conical and sized to fit into the support.

A “tamper” as used herein, is an object used for tamping, or compressing, smokeable material into the wrapper.

With reference to FIGS. 1 to 34, an apparatus 100, 200, 300, 400, 500, 600 having features of the invention can be used to quickly and easily make a cigarette made out of tobacco or other smokeable material. The apparatus 100, 200, 300, 400, 500, 600 can be portable, and is preferably sized to be hand-held.

A wall 102 provides the wall for an upper chamber 104 and a lower chamber 106. The chambers can be any shape, such as, for example, the chambers can have a circular or ovoid shape in horizontal cross-section. The wall 102 can be made out of any type of rigid material, such as, for example, plastic, glass, or metal. Part or all of the wall 102 can be transparent or translucent such that smokeable material is visible inside the upper chamber 104, lower chamber 106, or both chambers. Additionally, there can be decorative lights located in the wall 102.

The upper chamber 104 provides a receptacle for the feed smokeable material. The feed smokeable material can be directly placed in the upper chamber 104 upon separation of a lid 116 from the upper chamber 104, or there can be a fill inlet 156 such as a door or a flap in the wall 102 or lid 116 such that feed smokeable material can be placed in or added to the upper chamber 104 without separating the lid 116 from the upper chamber 104. The door can be removable and held in place with a snap on mechanism or hook and loop fiber material known as Velcro®, or hinged on the wall 102.

In one embodiment, the upper chamber 104 contains a manual or automatic size reducer, described further below.

The apparatus 100, 200, 300, 400, 500, 600 contains a grate 112 located between the upper chamber 104 and the lower chamber 106, thereby separating the upper chamber 104 from the lower chamber 106. The grate 112 is made out of a rigid or semi-rigid material such as, for example, plastic or metal. As shown in FIG. 5, the grate 112 contains holes 114 such that the cut smokeable material can pass through the grate 112 and into the lower chamber 106. The size of the holes 114 in the grate 112 can be from about 1 mm to about 10 mm in diameter with from about from about 4 to about 425 holes per square 25 mm. However, the holes 114 do not have to be circular; they can be any shape that allows the fill smokeable material to pass through the grate 112 from the upper chamber 104 to the lower chamber 106. All the holes need not be the same size. The grate 112 can be removable so that it can be cleaned, or so that a grate 112 with different sized holes 114 can be used.

As shown in FIGS. 4, 9, 13-15, 19-21, and 33-34, the lower chamber 106 has an opening so that cut, or fill, smokeable material can pass into an opening in the wrapper 120 within the support 110. Preferably, the opening in the lower chamber 106 is narrower at the bottom of the opening than at the top of the opening and is shaped like a funnel or cone.

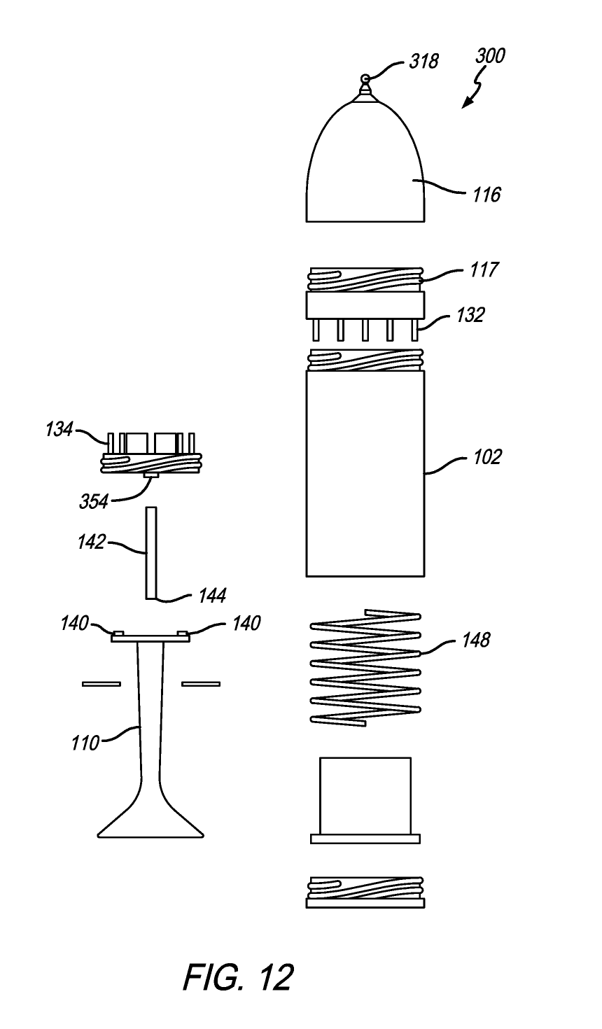

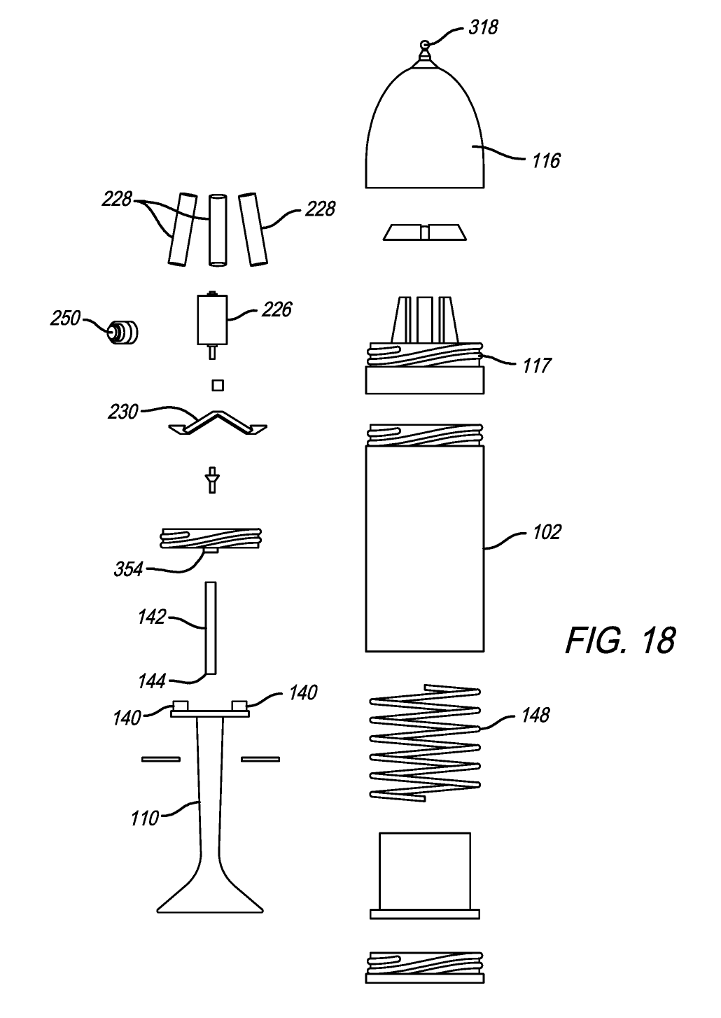

As shown in FIGS. 1-21 and 33-34, the apparatus 100, 200, 300, 400, 600 can have a lid 116 above the upper chamber 104. As shown in FIGS. 12, and 18, it is contemplated that the lid 116 can be removable from the upper chamber 104 by, for example, threads 117 that unscrew and separate the lid 116 from the upper chamber 104. As shown in FIGS. 4, 9, 31 and 32, the lid 116 can also be joined to the upper chamber 104 by, for example, a hinge 152, and as such the lid 116 flips off the upper chamber 104 but remains connected to the upper chamber 104 by the hinge 152. The lid 116 can also be attached to the upper chamber by other mechanical fastening means, such as a latch or slip fit.

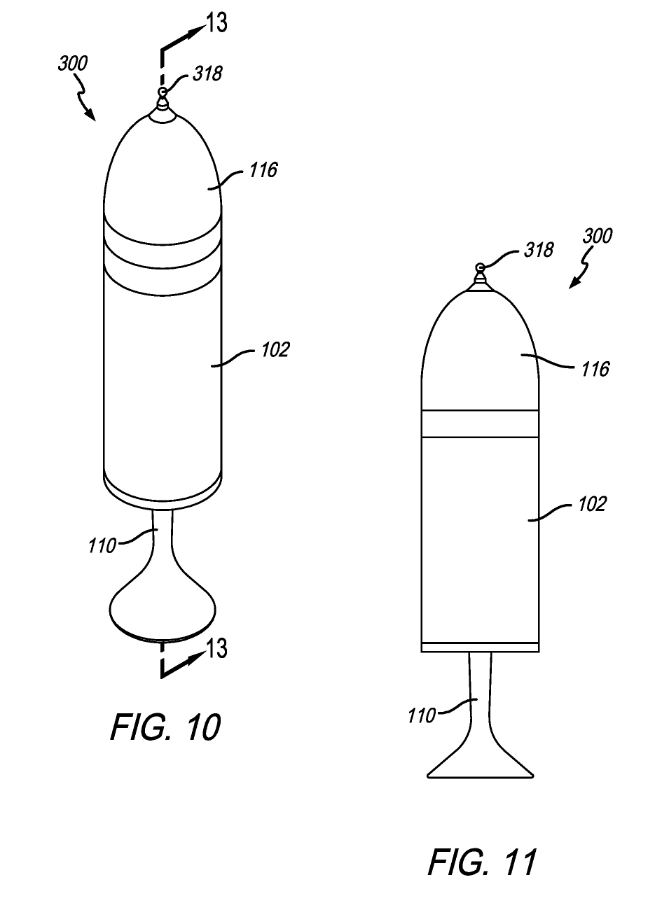

In one embodiment, as shown in FIGS. 10-21, the lid 116 can have a pushing projection 318 sized for pushing the wrapper 120 containing smokeable material partly out of the support 110. Although it is preferred that the projection 318 is on the lid 116, it can be on other places on the wall 102. Also, more than one pushing projection 318 can be provided.

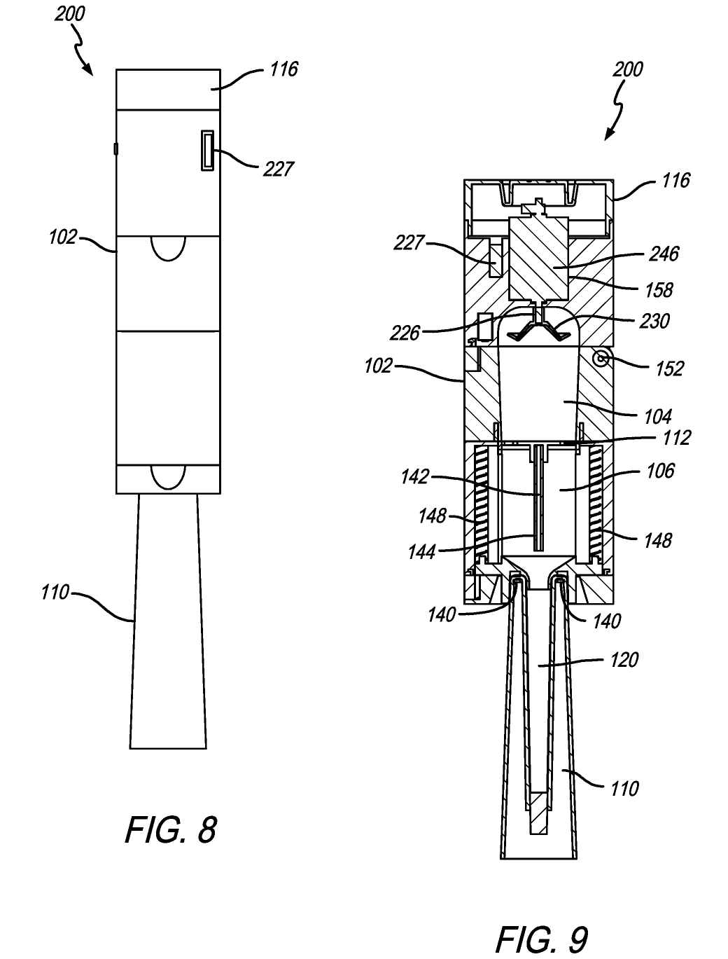

In another embodiment, as shown in FIG. 8, the apparatus 100, 200, 300, 400, 500, 600 can contain means for electrically charging the apparatus such as, for example, a USB port 227 or port for a battery charger such as a DC port.

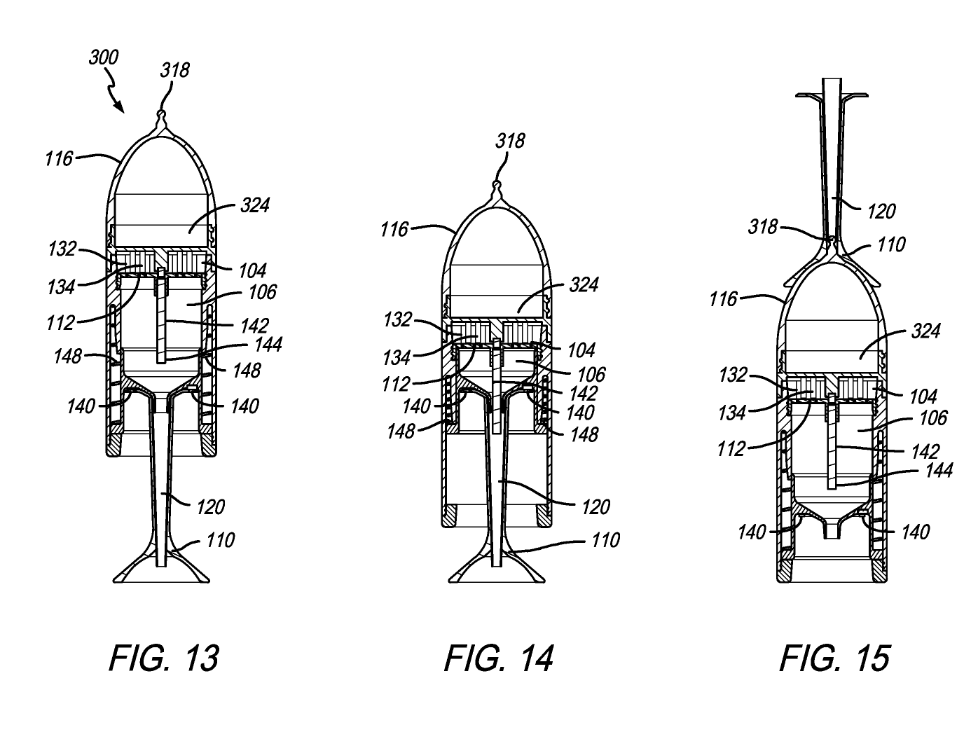

The apparatus 300, 400 can also have a storage area 324 for storing the smokeable material, as shown in FIGS. 13-15 and 19-21. Preferably, the storage area 324 is located above the upper chamber 104. The storage area 324 can be accessed by separating the storage area 324 from the upper chamber 104, or it can be accessed by the fill inlet 156.

In one embodiment, as shown in FIGS. 4, 9, 33 and 34, there is a cavity 158 above the upper chamber 104. The cavity 158 can contain a motor 246 if the device is powered. Alternatively, the motor 246 can be located in the lower chamber 106, The cavity 158 can also contain the energy source 228 for powering the motor 246, such as, for example, a battery holder and batteries. Also, the device can be externally powered such as by AC current.

The upper chamber 104 can be accessed by unfastening a portion of the wall 102, such as, for example, unfastening the lid 116, as shown in FIGS, 12 and 18.

As shown in FIGS. 4, 9, 12-15, 18-21, and 33-34, the apparatus 100, 200, 300, 400, 600 also contains a size reducer in the upper chamber 104 for reducing the size of the feed smokeable material into fill smokeable material such that the fill smokeable material can pass through the holes 114 in the grate 112 and into the lower chamber 106. However, some or all of the feed smokeable material may already be sized to pass through the grate 112. Thus, the size reducer does not always need to be used.

Any mechanism for reducing the size of feed smokeable material can be used; however, it is contemplated that the mechanism can be a blade, a grinder, a chopper, a mincer, or a combination thereof. The size reducer, also referred to as a comminution device, can be activated manually or automatically by, for example, closing or fastening the upper chamber 104 to the lower chamber 106.

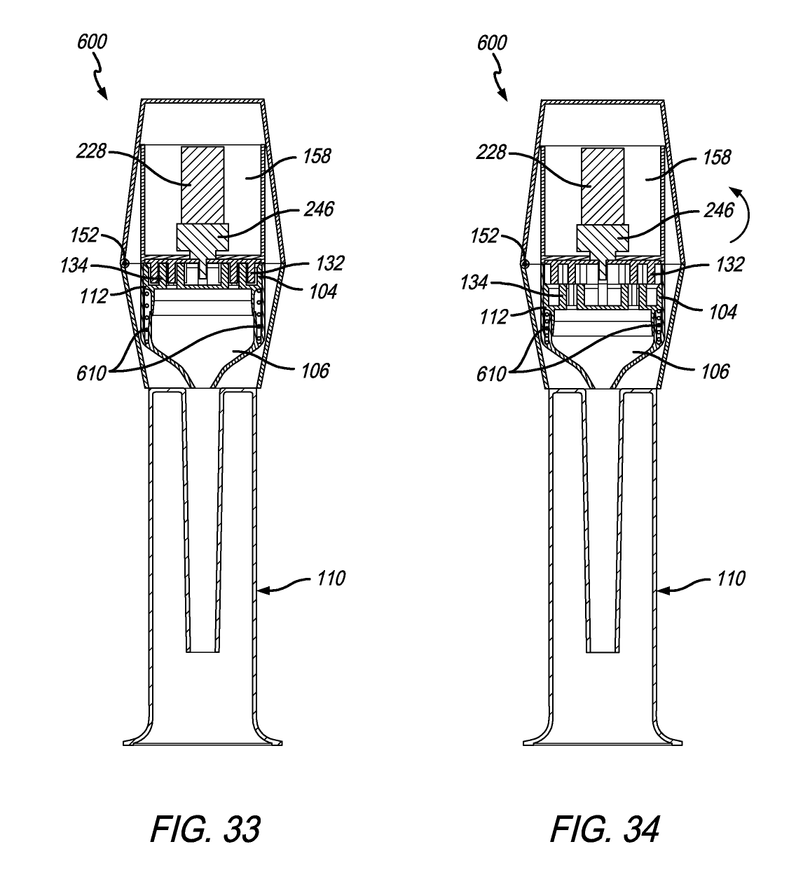

An exemplary size reducer that can be used manually or powered with the motor 246 is a grinder having a first plate with grinding projections 132 opposed to a second plate having a grinding surface with grinding projections 134 for grinding feed smokeable material therebetween, as shown in FIGS. 4, 9, 12-15 and 33-34. In one aspect, the second plate having a grinding surface with grinding projections 134 can be attached to the grate 112. As shown in FIGS. 33-34, it is contemplated that the apparatus 600 can contain biasing means 610 for biasing the grinder having a first plate with grinding projections 132 towards the second plate having a grinding surface with grinding projections 134, and alternatively biasing the second plate with grinding projections 134 towards the first plate with grinding projections 132. The plates are spaced apart from each other when there is feed smokeable material between them, and move towards each other when the volume of the feed smokeable material is reduced to fill smokeable material and passes through the grate 112. The biasing means can be, for example, a spring which can provide 1 to 5 pounds of force.

The size reducer can be moveable, with a first position distal from the grate and a second position closer to the grate. The moveable size reducer can contain biasing means for biasing the size reducer to the second position.

With a manual rotatable size reducer, as shown in FIGS. 4 and 12-15, the upper portion of the wall containing the upper chamber 104 can be rotatable relative to the lower portion of the wall containing the lower chamber 106 and is graspable by a user's hand. In use, a user grasps the upper portion of the wall containing the upper chamber 104 in one hand, the lower portion of the wall containing the lower chamber 106 in the other hand, and twists the two portions relative to each other.

The apparatus 100, 200, 300, 400, 600 also can contain a support 110 as shown in FIGS. 1-21 and 33-34. The support 110 is used to support the wrapper 120 below the lower chamber 106. The support 110 has one or more generally cylindrical elongated openings, or channels, for receiving and holding the wrapper 120. The support 110 can extend through the opening of the lower chamber 106. In one aspect, the support 110 is removably attached to the lower chamber 106 by, for example, magnets 140.

The wrapper 120 can be made from paper or other combustible material. The wrapper 120 is sized to fit into the support 110. For example, the size of the wrapper 120 can be between about 15 cm and about 50 cm long, and can be up to 5 cm wide in diameter at the top and 10 mm wide in diameter at the bottom if conical. The shape of the wrapper 120 can be any shape to fit the support 110, for example, it can be conical or straight. A conically shaped wrapper 120 can have a larger diameter at the fill end and a small diameter at the opposite end. The wrapper 120 has a sealed end that, in use, is placed at the lower end of the support 110, and an open end at the top of the support 110. The wrapper 120 can extend out of the lower end of the support 110. The apparatus 100, 200, 300, 400 can be provided with multiple supports 110, such as a conical support for conical wrappers and a support with substantially constant internal diameter for straight wrappers.

The support 110 can be removed from the lower chamber 106 of the wall 102 and attached to the lid 116 such that the projection 318 on the lid 116 can push the wrapper 120 containing smokeable material partly out of the support 110, as shown in FIGS. 15 and 21.

Alternatively, the support 110 can contain a pusher for pushing the wrapper 120 along the channel by pushing against the bottom or sealed end of the wrapper 120 extending out of the support 110. The pusher can be U-shaped with a pair of legs and a base therebetween. The pusher can be longitudinally movable in parallel with the longitudinal axis of the wall 102. Using the pusher, the wrapper 120 can be removed from the support by pushing the wrapper with the pusher along the channel against the bottom end of the wrapper 120. The fill end of the wrapper 120 will then extend out of the channel and can be removed from the channel by pulling on the extended fill end of the wrapper 120.

Another exemplary automatic size reducing mechanism, shown in FIGS. 9 and 18-21 is a rotatable size reducer, such as a rotatable blade 230, which is rotatable from 1 to 360 degrees in a clockwise direction, counterclockwise direction, or both directions. It is not a requirement that the blade can fully rotate 360 degrees.

As shown in FIGS. 9, 19-21 and 33-34, in the apparatus 200, 400, 600 containing an automatic size reducing mechanism, there is a drive 226 that is connected to the motor 246 with a power source 238 for rotating the automatic rotatable size reducer. A typical motor 246 has a horsepower of from about 0.001 to 4. The power source 238 can be powered by an electric current provided by an alternating current (AC) or a direct current (DC). Sources of direct current are, for example, batteries, thermocouples, and solar cells. The motor 246 can be controlled by a switch 250 used to turn the power source 238 off and on, or incrementally varying the speed of the motor 246. It is contemplated that the motor 246 can be run at variable speeds.

There can also be a controller or control circuit coupled to the motor 246 for controlling the motor 246 in order to provide variable speed and change of direction for the automatic rotatable size reducer and a predetermined amount of total rotation. If the rotatable size reducer encounters excessive resistance when grinding the feed smokeable material, the control circuit can reverse the direction of rotation of the rotatable size reducer in order to continue to grind the feed smokeable material, or stop the rotation completely. The controller can be associated with software that enables the changes in direction automatically at a set time point. The software can change the direction of the rotatable size reducer when resistance in the motor 246 during grinding is detected above a certain amount. For example, if the normal operating amperage is 2.2 A and the rotatable size reducer encounters resistance, when the amperage reaches 3 A, the control circuit can cause the motor 246 to change the direction of rotation of the rotatable size reducer. If the drawn amperage reaches 5 A, the motor automatically shuts down.

The control circuit can also start the motor 246 automatically when the feed smokeable material is loaded into the apparatus 200, 400, 600 and the apparatus is assembled or closed. The control circuit can be configured to automatically turn off the motor 246 after the rotatable size reducer has rotated for a predetermined amount of time such as, for example from about 3 to about 10 seconds, from about 4 to 8 seconds, or about 20 seconds after the motor 246 is turned on. Preferably, the control circuit can automatically reverse the direction of rotation at least twice. For example, the duration of rotation can be changed from about 1 to about 10 seconds. The controller can stop rotation of the size reducer prior to reversing the direction of rotation. Preferably, the control circuit changes the direction of rotation of the rotatable size reducer almost instantaneously when the rotatable size reducer encounters resistance. Additionally, the control circuit can prevent operation of the motor 246 as well as stop the motor 246 when the apparatus is opened during operation.

The apparatus can comprise a detector for detecting the strength of the current, typically the amperage, provided to the motor 246 and providing an output signal based on the strength detected. The control circuit is adapted to reverse the direction of rotation of the size reducer when the detected strength exceeds a predetermined amount.

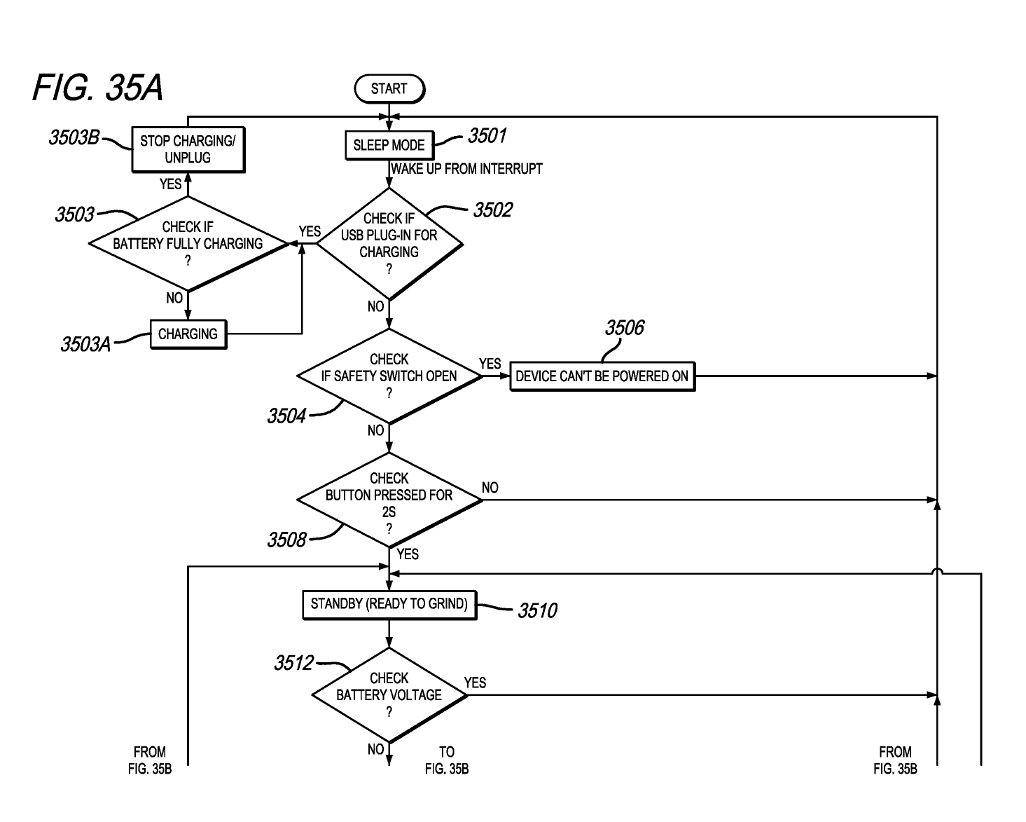

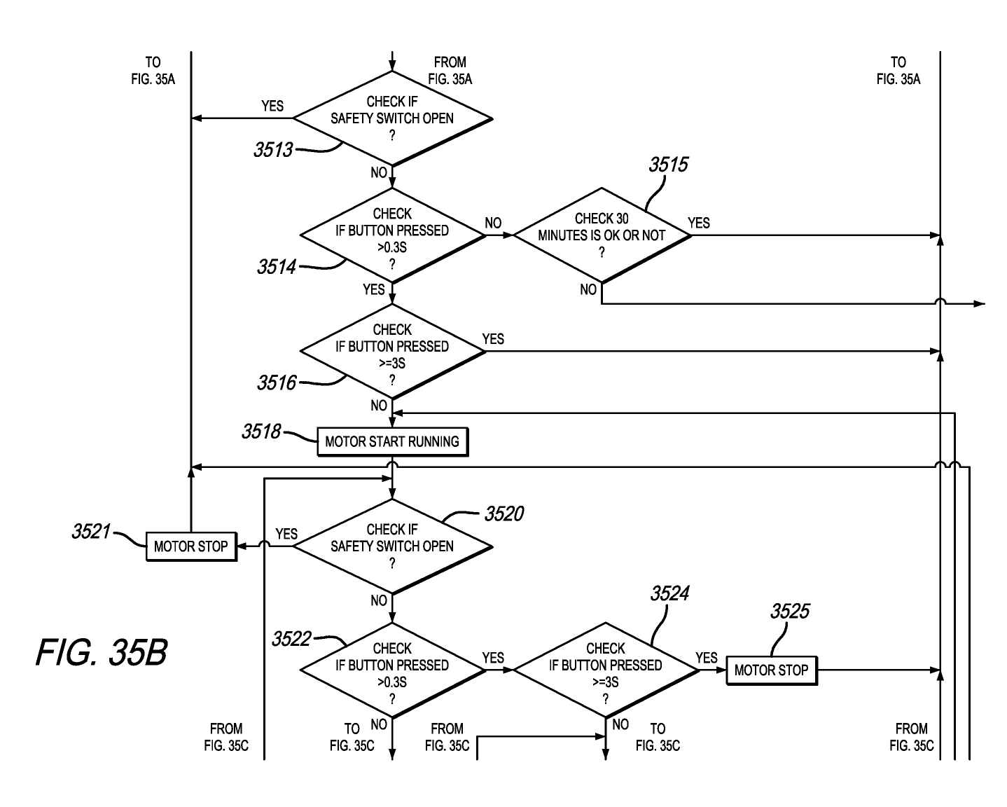

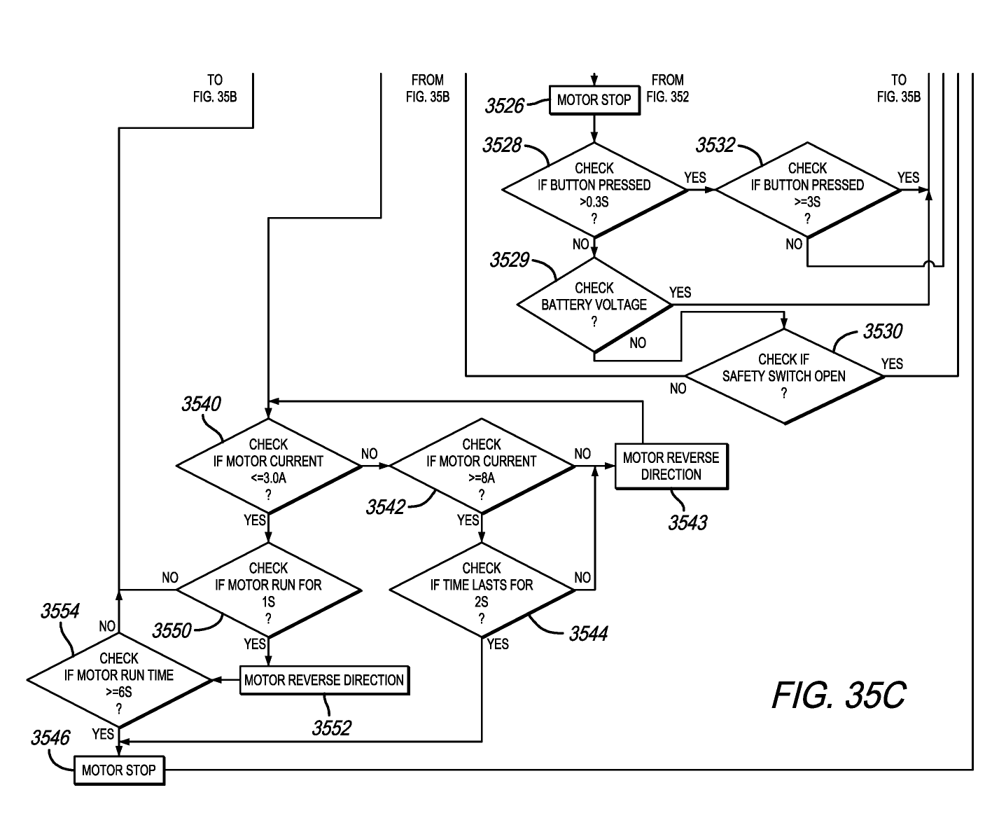

With reference to FIG. 35, there is a flow chart for software that can be installed on an apparatus for automatic control, particularly when a motor 246 is provided. The software is useful for operating any of the apparatus 100, 200, 300, 400, 500, 600 shown in the drawings, and can be installed on a microprocessor or other system control device. The software can be stored in memory of a controller. A conventional device controller receives data and stores it temporarily in some special purpose registers (i.e. local buffer) inside the controller. Then it communicates the data with a driver.

In particular, once the system is activated it remains in a sleep mode 3501 until it wakes up from an interrupt such as being plugged into a power source or activated by a switch 250. While in the sleep mode 3501 the device monitors 3502 for being plugged into a power source such as through a USB port. If it is plugged in, the device check if the battery is fully charged 3503, and if not, it charges the battery 3503A. Also, the system can optionally signal the user to charge the battery and/or advise the user of the battery charge level. If the battery is fully charged, charging is stopped 3503B. If it is not, the system can check if the battery is fully charged. If the apparatus 100, 200, 300, 400, 500, 600 utilizes only external power or is not powered with a power source such as by a user powering the device mechanically, the battery check is not needed.

While in the sleep mode, the system checks if a safety switch is open 3504. A safety switch is used to determine if the access used for loading the smokeable material is open or closed. It is undesirable for a user to contact the size reducer mechanism. If the switch is in the open position, the system cannot be powered on 3506 and proceeds back to sleep mode 3501. If the safety switch is closed, the system can operate and checks if the user has pressed an activation button for at least two seconds 3508. If the user has pressed the button for at least two seconds, the system proceeds to standby mode 3510, ready to grind. Until that happens, the system remains in sleep mode 3501.

After detecting that the button was pressed for at least two seconds, while in standby mode 3510, the system checks the battery voltage level 3512. This is to make sure that enough power is available to run the device. If there is not enough voltage detected, such as less than 3.4 volts, the system reverts to the sleep mode 3501 and preferably provides a signal to the user of the low battery charge, such as with LED light(s). Also, while in standby mode 3510, the system checks if the safety switch is open 3513. If it is open, the system does not leave standby mode 3510 and the size reducing mechanism cannot be activated.

While in standby mode 3510, the system monitors 3514 for the user pressing the button again for a minimum predetermined time, such as 0.3 seconds. If that does not occur for a predetermined time 3515, such as 30 minutes, the system reverts to sleep mode 3501. If that occurs in the 30-minute window, the system checks if the button press was less than another greater predetermined time 3516, such as 3 seconds. If the button is pressed more than the greater predetermined time, the system reverts to sleep mode 3501; effectively, the user has turned off the apparatus. If the button is pressed for the right amount of time, which in this specific case means more than 0.3 seconds and no greater than 3 seconds, then the motor 246 starts the size reducing operation 3518. While the motor 246 is running, the status of the safety switch is monitored 3520, and if it is open the system reverts to standby mode 3510 and the motor 246 stops 3521.

The user can interrupt the grinding operation by pressing the button for a predetermined time 3522, such as at least 0.3 seconds. If that occurs, the system checks if the button press was greater than 3 seconds 3524, in which case the motor stops 3525 and the system reverts to sleep mode 3501. If the press is less than 3 seconds, the motor stops 3526 and the system monitors 3528 for another button push of at least 0.3 seconds.

Until there is the additional push of at least 0.3 seconds, the system monitors 3529 battery voltage and monitors 3530 for the position of the safety switch. If the voltage is too low, the system reverts to sleep mode 3501 and preferably a signal is sent to the user such as with one or more LEDs. If the safety switch is open such as by the user opening the device to load it, the system goes to standby mode 3510. If the button is pressed for more than 0.3 seconds, the system checks 3532 if the button was pressed for at least 3 seconds. If the button was pressed for at least 3 seconds the system reverts to the sleep mode 3501; if less than 3 seconds the motor starts running again 3516. Thus, the user has taken over direct control of the apparatus.

Preferably the system signals the user that the safety switch is open whenever it is open, such as by use of one or more LEDs.

While the motor 246 is running, the motor current is continually sensed 3540 with a current sensor to determine if there is a jam in the size reducing mechanism. For example, if the current draw is greater than 3 amps, then the current draw is checked 3542 for a higher value such as 8 amps. If it is less than 8 amps, the motor 246 reverses direction 3543. If it is more than 8 amps for a predetermined time such as 2 seconds, as shown by block 3544, the motor 246 stops 3546.

While the motor 246 is running, reversal of direction of rotation occurs at a predetermined interval. With regard to blocks 3550 and 3552 in the flow chart, the there is an automatic reversal of direction of rotation 3552 at a set interval, such as 1 second. Thus, motor reversal is preferably automatic, and can occur out of cycle if there is increased amperage draw 3542 indicating a partial or full jam of the cutting mechanism. The motor runs for a predetermined time 3554 such as 6 seconds, continually monitoring 3520 the status of the safety switch, going to standby mode 3510 if the safety switch is open.

In one instance, once activated by a switch 250, the controller causes the motor 246 to rotate the cutting mechanism for 2 seconds before reversing, repeating the rotation every 2 seconds until a total of 8 seconds has elapsed. At 8 seconds, the motor 246 stops. If desired, the user can activate the switch 250 again to go through another 8 second cycle.

All references to an amount of time and amperage are exemplary. The system can be set for any predetermined time and any predetermined amperage.

Preferably the system is provided with status indicators, using devices such as LEDs, to alert the user to such actions as the current mode of the system, the battery charge level, a grinding jam, that the safety switch is open, the motor 246 is running, reduction in size of the fill smokeable material is completed, direction of rotation, and the like.

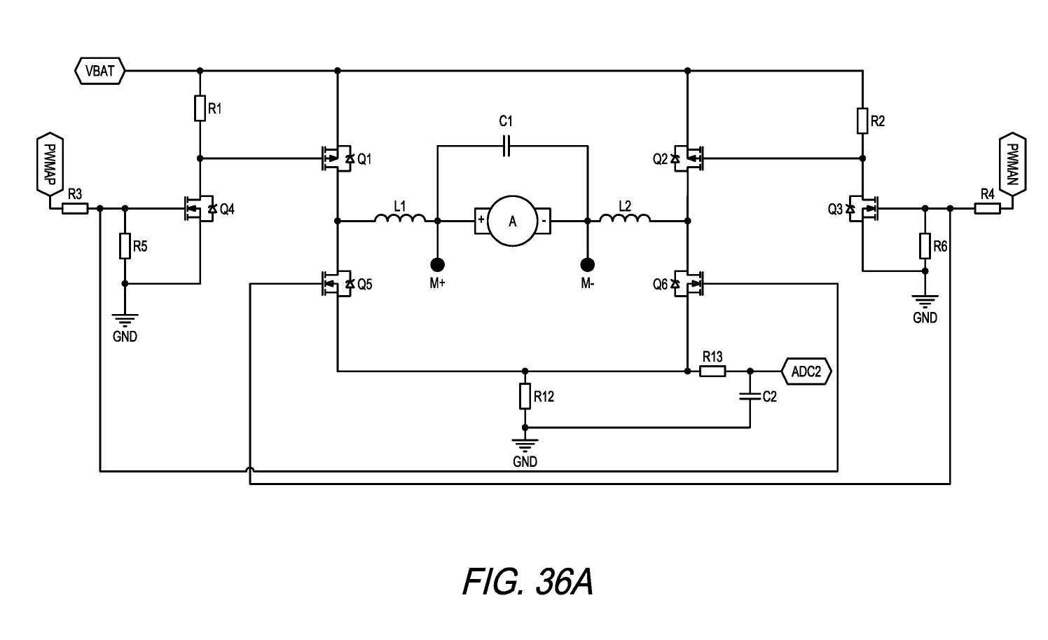

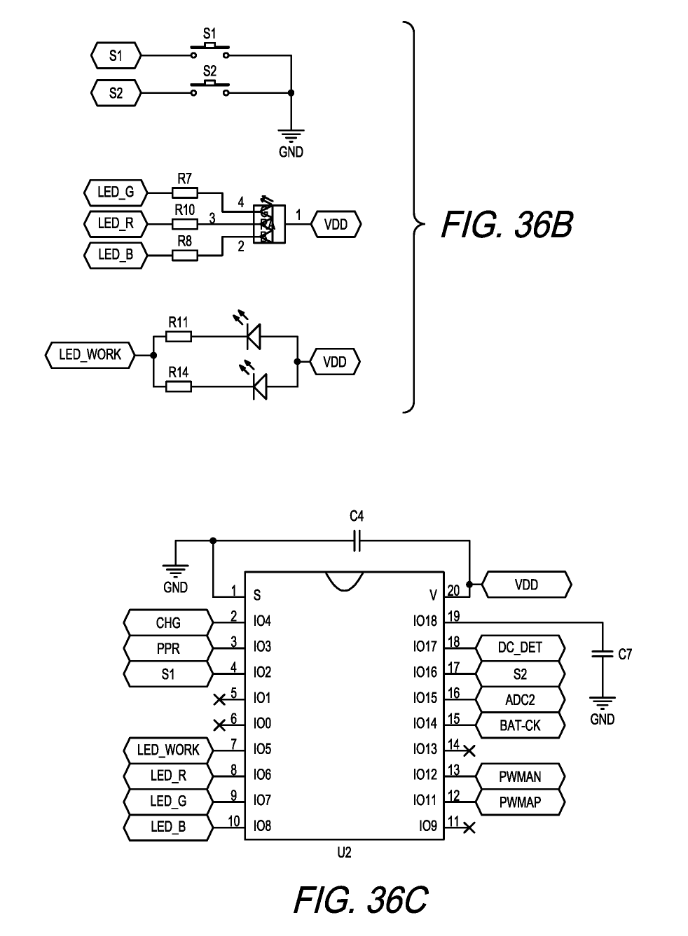

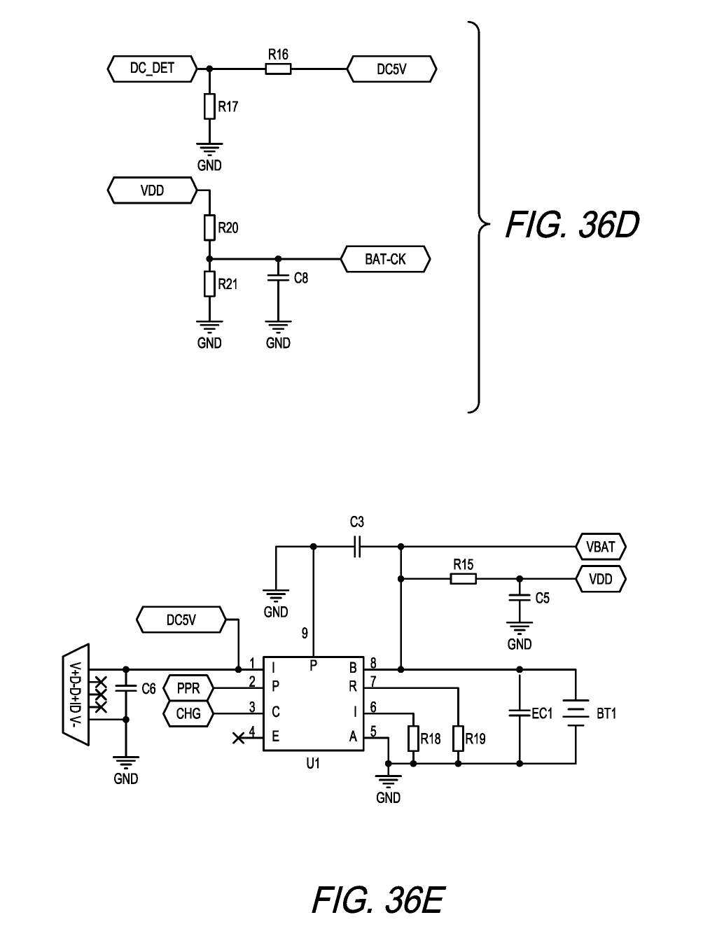

With reference to FIG. 36, there is shown a schematic including the control circuit for controlling the motor 246 and thus the rotation of the rotatable size reducer. In particular FIG. 36A shows a typical H bridge pulse width modulated (PWM) DC motor control circuit. FIG. 36B shows a PWM control circuit utilizing a micro control unit. FIG. 36C provides a signal to a micro controller that enough voltage is available to run the transistors in the H bridge. FIG. 36D shows a typical lithium battery charging circuit for powering the motor 246. FIG. 36E shows a circuit for the LED light indicators. The switches are for controlling the micro controller via micro controller pins S1 and S2.

The circuit shown in FIG. 36 can be used to implement the flow chart of FIG. 35, as a controller.

In addition, the motor 246 can be used to vibrate, or shake, the entire apparatus 200, 400, 600 such that the fill smokeable material passes from the upper chamber 104, through the grate 112, into the lower chamber 106, and into the wrapper 120. It is contemplated that one or more than one motor 246 can be used to vibrate the apparatus in an apparatus containing either manual or automatic size reducers to aid in packing the fill smokeable material into the wrapper 120. A suitable motor 246 that can cause vibration and drive the size reducer is any micro DC motor or brushless motor, as described above, as long as the motor 246 is powerful enough to shake the wall 102 or entire device. Alternatively, a counterweight can be mounted to the motor shaft which causes vibration though the entire apparatus. In one embodiment, the vibration of the apparatus 200, 400 causes the free end 144 of the tamper 142 to whip back and forth. The whipping action also helps to pack the smokeable material into the wrapper 120.

As shown in FIGS. 4, 9, 12-15, and 18-21, the apparatus 100, 200, 300, 400 can contain a tamper 142 for tamping smokeable material into the wrapper 120. The tamper 142 is located in the lower chamber 106, and can be secured or removably secured to the grate 112. The tamper 142 is axially movable, having an upper position and a lower position such that the fill smokeable material is tamped into the wrapper 120. The free end 144 of the tamper 142 is sized so that it can fit into the open end of the wrapper 120. Preferably, the tamper 142 also provides a piston-like effect so that pushing downwardly compresses air in the lower chamber, thereby forcing fill smokeable material into the open end of the wrapper 120 and compressing it therein for a consistent, uniform smoke. In one embodiment, it is contemplated that the tamper 142 can be removably secured to the grate 112 by means of a magnet 354 as shown in FIGS. 12 and 18.

The tamper 142 can be rigid or flexible depending on the hardness of the material used. Preferably, the tamper 142 can be made from a soft material, such as, for example, a polymer such as rubber, or a spring such as a metal spring. The hardness of the tamper 142 is in the range of from about 15-30 on a durometer shore OO hardness scale and up to 80 on a durometer shore D hardness scale. It is contemplated that the tamper 142 can be removable and replaceable, and thus sold separately from the remainder of the apparatus 100, 200, 300, 400 so that tampers of different hardness, and thus different flexibilities, can be used or worn out tampers 142 can be replaced. In one aspect, only the bottom portion of the tamper 142 need be flexible.

The apparatus 100, 200, 300, 400 is biased so that the wall 102 and the tamper 142 are in an upper position, as shown in FIGS. 4, 9, 13 and 19. The biasing can be done via any biasing means, such as, for example, a piston or one or more springs 148 located, for example, within the wall of the apparatus 100, 200, 300, 400, as shown in FIGS. 4, 9, 13-15 and 19-21. In one embodiment, the spring 148 can be sized to span the circumference of the wall 102. Alternatively, there can be two springs 148 placed on opposite sides of the wall 102.

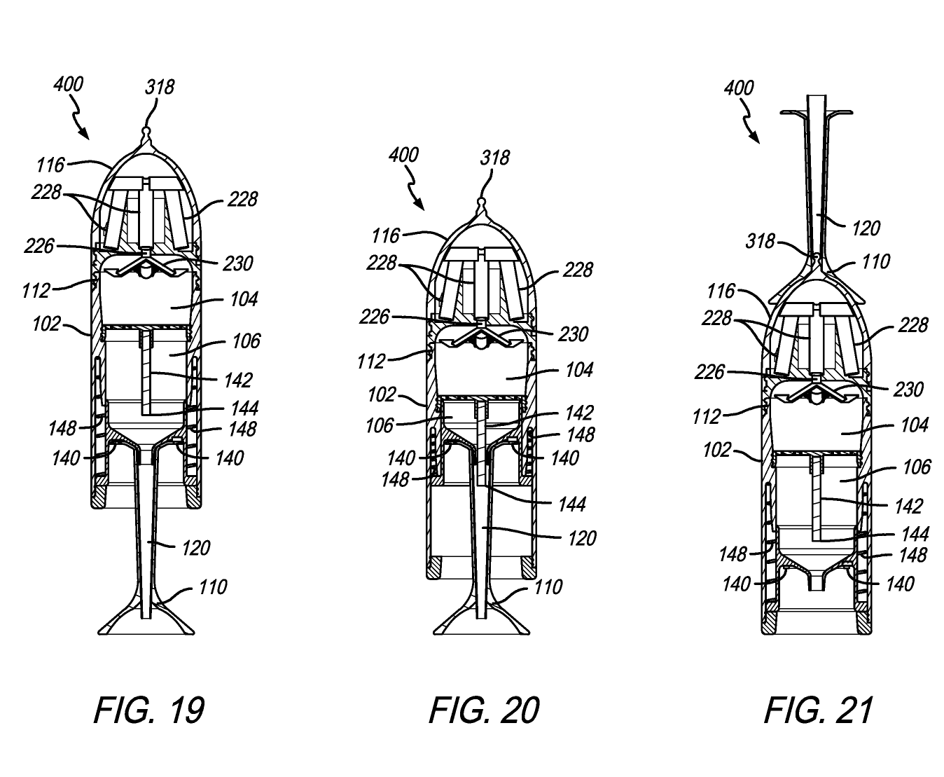

In use, the wall 102 is movable downwardly from an upper position to a lower position relative to the support 110 for moving the grate 112 downwardly, thus causing the tamper 142 to move downwardly for tamping smokeable material in the wrapper 120. FIGS. 13 and 19 show an embodiment of the apparatus 300, 400 and tamper 142 in a first upper position. The user can push the top of the apparatus 300, 400 in a downward direction, axially moving the tamper 142 so that the tamper 142 moves to a second lower position into the wrapper 120 as shown in FIGS. 14 and 20. The user then releases the top of the apparatus 300, 400 such that the tamper 142 returns to the first position. The user can remove the support 110 from the lower chamber 106, and use the projection 318 on the lid 116 to push the wrapper 120 out of the support 110, as shown in FIGS. 15 and 21.

The apparatus 100, 200, 300, 400, 600 of the invention preferably contains one or more of the elements described above integrated into a single device, preferably sized to be hand-held.

The invention also provides a kit containing an apparatus 100, 200, 300, 400 for preparing a smokeable product, as described above. The kit contains a removable first tamper 142. The kit also contains one or more removable second tampers 142. The removable second tamper 142 can have a hardness that is identical to the first tamper 142. Alternatively, the second tamper 142 can be more hard or less hard than the first tamper 142.

An alternate kit of the invention can contain an apparatus 100, 200, 300, 400, 600 as described above with a removable first grate 112. The kit also contains a removable second grate 112 with holes that differ in size from the first grate 112. It is also contemplated that a kit of the invention contains both removable and replaceable tampers 142 and removable and replaceable grates 112.

In use, a user places feed smokeable material through the fill inlet into the upper chamber 104. The user also places a wrapper 120 in the support 110 and places the support on the apparatus 100, 200, 300, 400, 600. The user then activates the size reducer so at least a portion of the feed smokeable material falls through the grate 112 as fill smokeable material into the lower chamber 106.

For operation of the size reducer in an apparatus 100, 300 with a manual size reducer such as a grinder, the user can, for example, twist the portion of the apparatus 100, 300 containing the wall 102 with the upper chamber 104 containing the first grinding plate 132 in a clockwise direction, while simultaneously twisting the lower chamber 106 the second grinding plate 134 in the opposite, counterclockwise direction. Alternatively, the direction of rotation can be switched. Also, only one of the grinding plates needs to be rotated. Once most or all of the feed smokeable material is sized to fall through the grate 112, the user can stop twisting the upper 104 and lower chambers 106. Alternatively, for operation of the size reducer in an apparatus 200, 400 with an automatic size reducer, such as a rotatable blade 230, the user can, for example, switch on the motor 246 via a switch 250 on the outside of the apparatus 200, 400. The motor 246 is attached to a drive 226, which drives power to the rotatable blade 230 so that it can rotate. Once most or all of the feed smokeable material is sized to fall through the grate 112, the user can switch off the motor 246.

The fill smokeable material thereafter falls through the opening into the wrapper 120. If desired, the user can force the tamper 142 downwardly against the force of the biasing means for tamping fill smokeable material in the wrapper 120. If needed, the user can inspect the wrapper 120 for the desired amount of fill smokeable material in the wrapper 120, and thereafter repeats the steps one or more times until the desired amount of fill smokeable material is contained in the wrapper 120.

Thereafter, the user can remove the support 110 from the lower chamber 106 and remove the filled wrapper 120 from the support 110. In one aspect, the user can remove the support 110 from the lower chamber 106 and use the projection 318 on the lid 116 to push the wrapper 120 containing fill smokeable material from the support 110. The user then closes the opening of the wrapper 120, thus forming a smokeable product.

The time for the smokeable product to be produced from the starting feed smokeable material is ten seconds or less.

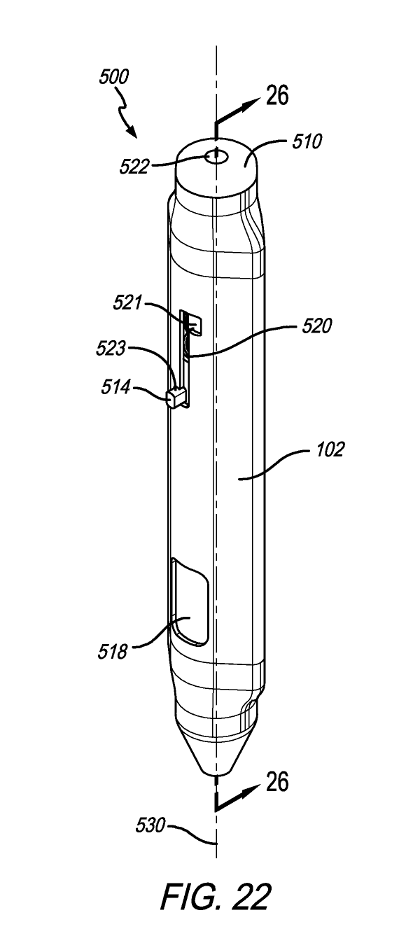

The invention also provides a cylindrical-shaped, elongate apparatus 500 for preparing a smokeable product, as shown in FIGS. 22-30, The apparatus 500 has a longitudinal axis 530 and comprises a wall 102 with an upper chamber 104 and lower chamber 106. As described above, the wall 102 can be made out of any type of rigid material, such as, for example, plastic, glass, or metal. Part or all of the wall 102 can be transparent or translucent such that feed smokeable material 522 is visible inside one or both chambers. The lower chamber 106 has an opening 156 so that fill smokeable material 534 can pass out of the lower chamber 106.

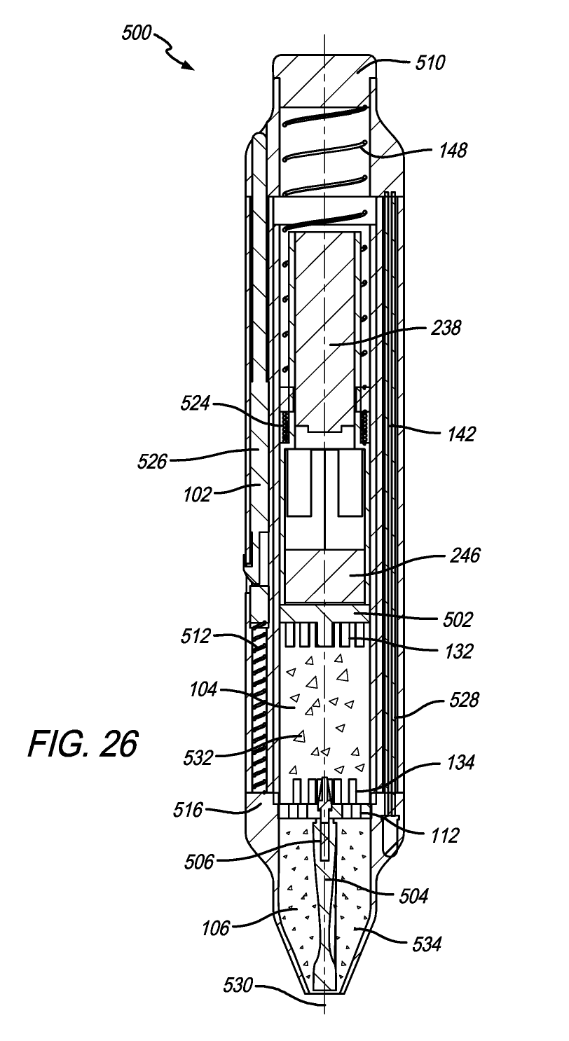

The wall 102 has a fill inlet 156 so that feed smokeable material 532 can be added to the upper chamber 104, as shown in FIGS. 26 and 28. The fill inlet 156 can have a moveable closure or door 518 that can be opened and shut such that the fill inlet 156 can be covered by the door 518 and that can be substantially closed so that feed smokeable material 532 is retained within the apparatus 500. The door 518 has a first open position, shown in FIG. 28, and a second closed position as shown in FIGS. 22-24 and 27. Preferably, the door 518 is biased to the closed, or second position. In one aspect, the door 518 biasing means is a spring 524, as shown in FIGS. 22, 23 and 26. Additionally, the apparatus 500 can have a locking mechanism, in the form of a projection 514 for locking the door 518 into either its first open position, shown in FIG. 28, or its closed position, as shown in FIGS. 22-24 and 27. The locking mechanism 514 can be located on the door 518. In one embodiment, the locking mechanism 514 fits into an opening in the wall 520 that has a longitudinal slot 520 and two transverse, generally circumferential slots, namely an upper slot 521 and a lower slot 523 on either end of the longitudinal slot 520, as shown in FIGS. 22, 23, 25, 27 and 28. The locking mechanism 514 slides into the upper transverse slot 521 so that the door 518 is locked in the first position so that feed smokeable material 532 can be added to the apparatus 500, as shown in FIG. 28, and locked in the second position using the lower slot 523 so that the feed smokeable material is retained in the apparatus 500, as shown in FIG. 28, particularly during a grinding function as discussed below.

Optionally, the door 518 can be removable and held in place with a snap-on mechanism or hook and loop fiber material such as Velcro®, or can be hinged on the wall 102.

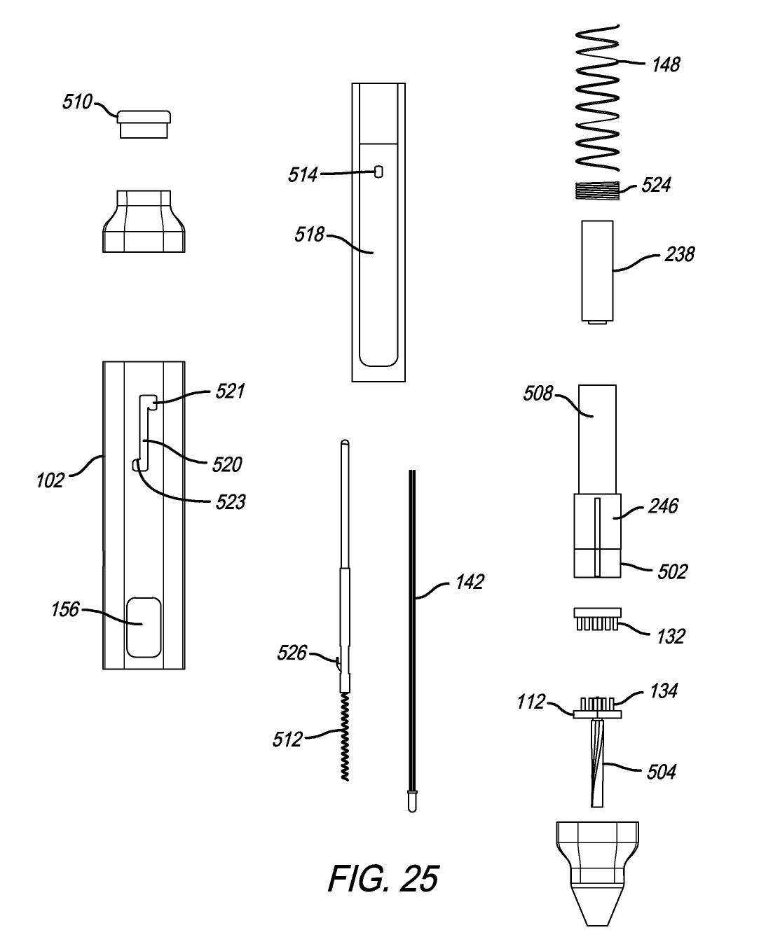

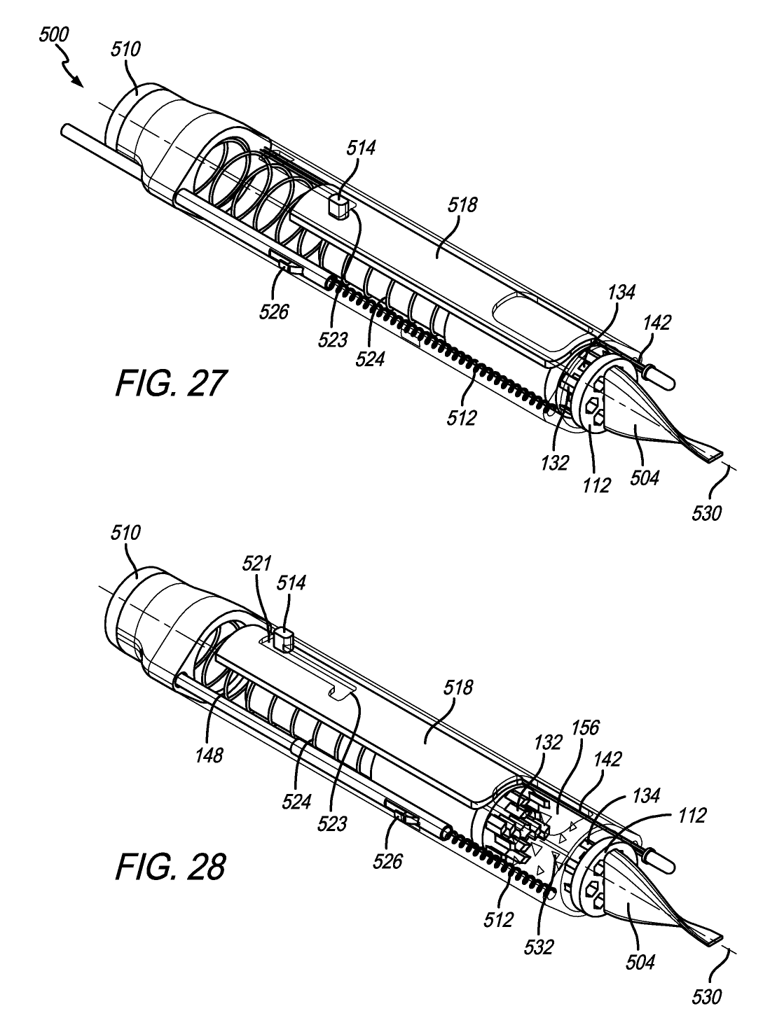

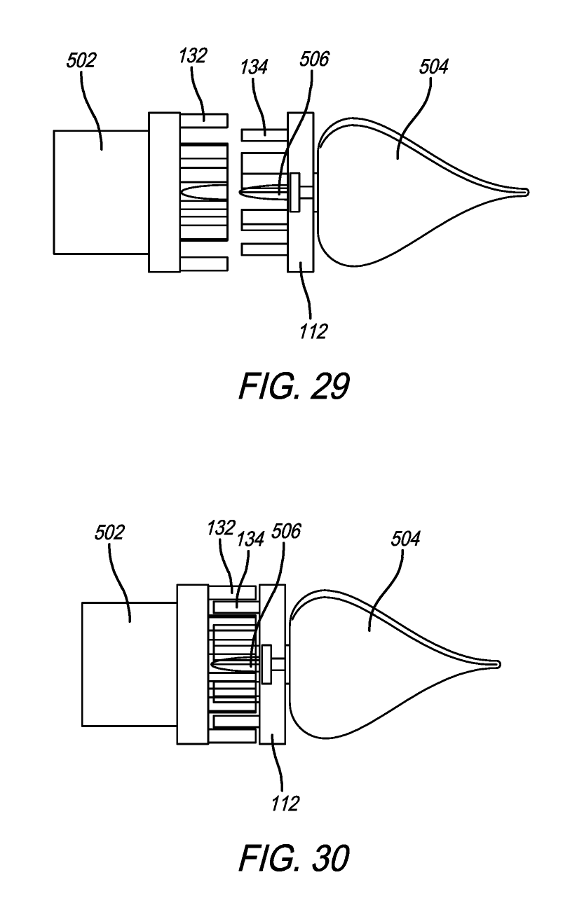

The apparatus 500 has a size reducer in the upper chamber 104 for reducing the size of the feed smokeable material 532 into fill smokeable material 534 such that the feed smokeable material 532 can pass through the holes 114 in the grate 112 and into the lower chamber 106 as fill smokeable material 534, as shown in FIG. 26. FIGS. 25-28 show one embodiment of the invention with a grinder having a first plate with grinding projections 132 opposed to a second plate with grinding projections 134. In one aspect, the second plate with grinding projections 134 can be attached to the grate 112. The size reducer comprising the first plate with grinding projections 132 is moveable along the longitudinal axis 530 of the wall 102 with a first position as shown in FIGS. 28 and 29 distal from the grate and a second position as shown in FIGS. 27 and 30 closer to the grate 112. The second position is for grinding the feed smokeable material 532. The first plate with grinding projections 132 and second plate with grinding projections 134 can be biased into the second position with the same biasing means that biases the door 156 in the closed position, described above.

In a powered version of the invention, the apparatus 500 preferably comprises a motor housing 508 containing the motor 246 for rotating the size reducer, a gearbox 502, and power source 238 such as a battery 238 for powering the motor 246, as shown in FIGS. 25-28. Optionally, external power instead of or in addition to the battery 238 can be used. The motor housing 508 is enclosed within the wall 102. Connected to the motor housing 508 is a cap 510 that contains a power button 522 and optionally a means to charge the battery 238 if a rechargeable battery is used, such as a USB charging port 156. The motor housing 508 is biased to the second position by means such as, for example, the spring 524. In one aspect, the spring 524 is located above the motor housing 508 and below the cap 510. The spring 524 is compressed when the motor housing 508 is in the first position, and extended when the motor housing 508 is in the second position. The spring 524 stops the grinding projections 132, 134 at the point of most resistance when the smokeable material is placed in the apparatus 500. The motor 246 can also have a controller associated with controlling the direction of the size reducer, as described above.

Once feed smokeable material 532 is placed in the upper chamber 104, the motor housing 508 is moved to a second position, such that the first plate with grinding projections 132 comes into contact with the second plate with grinding projections 134, as shown in FIGS. 27 and 30. The motor 246 is then activated with the switch 522 and the feed smokeable material is ground into fill smokeable material in between the first plate with grinding projections 132 and the second plate with grinding projections 134.

The lower chamber 106 contains a mover 504 that rotates both clockwise and counter-clockwise from 10 to 360 degrees. The mover 504 can be any shape that aids to push fill smokeable material 534 out of the lower chamber 106. For example, the mover 504 can be shaped like a paddle or propeller, as shown in FIGS. 27-30. The mover 504 can be either flexible or inflexible. In one aspect, the mover is made out of plastic, metal, rubber, or the like. In one aspect, the mover 504 is connected to the second plate with grinding projections 134 by a mover drive shaft 506, which propels the mover to rotate when the first plate with grinding projections 132 comes into contact with the second plate with grinding projections 134 when the motor housing 508 in in the second position and the motor 246 is activated.

The apparatus 500 preferably houses a tamper 142 that is stored within an elongated space 528 in the wall 102, as shown in FIGS. 26-28. The tamper 142 can be removed from the apparatus 502 and inserted into an opening 516 in the apparatus. Once in the opening 516, the tamper 142 is biased to a first position by, for example, a spring 512. The tamper 142 is laterally movable into a second position against the bias by a rod 526 located in the wall 102 of the apparatus 500.

A portion of the rod 526 extends out of the wall 102 and is laterally moveable in order to move the tamper into a second position so that the tamper 142 can aid to pack down the fill smokeable material 534 into a device or wrapper when moved from the first position to the second position. As shown in FIGS. 26-28, the tamper 142 can be provided housed into the elongated space 528, provided separately for placement in the space, or as part of a kit or provided separately.

In use, the user has the door locking mechanism 514, in the first position, shown in FIG. 28, against the spring 524, so that the fill inlet 156 is open. At the same time, the motor housing 508 and first plate with grinding projections 132 is in the first position. The user places material such as feed smokeable material in the apparatus 500 through the fill inlet 156. The user then moves the door locking mechanism 514 into the second position, closing the fill inlet 156 and moving the motor housing 508 and first plate with grinding projections 132 to the second position close to the grate 116. The user activates the motor 246 with the switch 522, causing the size reducer to reduce the size of the feed smokeable material 532 into fill smokeable material 534. Activating the grinder can continue as long as the switch 522 is on, or preferably for a set amount of time. Optionally, a controller can be provided for causing the motor to rotate the grinder in one direction and then in the reverse direction (such as clockwise to counterclockwise), one time, or automatically change direction of rotation multiple times, as described above.

The fill smokeable material 534 passes through the grate 112 and into the lower chamber 106. The mover 504 rotates, pushing the fill smokeable material 534 out of the opening in the lower chamber 106. The fill smokeable material 534 can then be used to fill a pipe, wrapper, bong, or other smoking device directly from the outlet of the lower chamber 104, or can be kept for later use. If desired, the user can remove the tamper 142 from the elongated space 528 for tamping the fill smokeable material 534 into the smoking device.

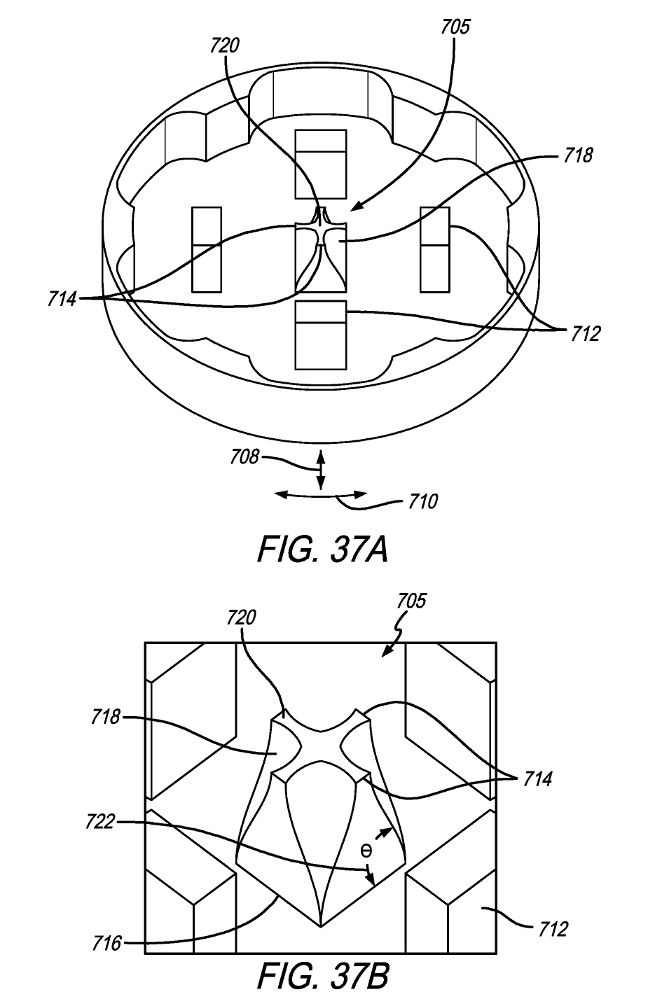

With reference to FIGS. 37A and B, a cutting mechanism such as a grinder can become clogged due to accumulation of smokeable material, particularly around a central projection 705, also referred to as an axial projection, because as the grinder rotates, the outer projections 712 distal from the longitudinal axis 708, rotates around the rotational axis 710, but the central projection 705, although it rotates, remains stationary with respect to the rotational axis 710. To prevent such accumulation, it is desirable that the central projection 705 has cutting blades 714. The central projection 705 has a base 716, a side surface 718, and a surface 720 opposed to the base 716, with the cutting blades 714 projecting from its side surface 718. The cutting blades 714 can extend at an angle of from about 80 degrees to about 10 degrees, and preferably 30 degrees away from the base 716 of the central projection 705 relative to the plane of the side surface 718 as shown by angle 722.

### EXAMPLES

### Example 1

### Apparatus

An apparatus to prepare a smokeable product was assembled. The size of the apparatus is approximately 150 mm at the maximum diameter. The apparatus had a wall which provided an upper chamber and a lower chamber. There was a grate located between the chambers. The hole size of the grate was 5 mm with 30 holes per square 25 cm. The apparatus also had a removable lid above the upper chamber for placing feed smokeable material into the upper chamber. The lid contained a projection that can be used for pushing a filled wrapper out of the support.

Also in the lid area was a motor, a power source for powering the motor, and a drive between the motor and a rotatable blade to rotate the blade. The rotatable blade was located on the upper surface of the wall of the upper chamber. The speed of the motor was varied by means of a switch located on the outside of the wall.

The apparatus also had a support below the lower chamber for supporting a paper wrapper. The support was removably attached to the lower chamber by magnets. The support was 130 mm long and 24 mm wide. The wrapper was conically shaped and was 100 mm long, 10 mm in diameter at the top and 5 mm in diameter at the bottom. The wrapper was sealed at the bottom before it was placed into the support. The lower chamber had an opening for fill smokeable material to pass into the wrapper. The apparatus also had an axially movable tamper made out of rubber located in the lower chamber. The tamper had an upper position and a lower position. There was a spring for biasing the tamper into its upper position, as well as a mechanism for moving the tamper from its upper position to its lower position against the spring biasing means.

### Example 2

### Method of Using the Apparatus

The apparatus described in Example 1 was used to fill a cigarette. To use, the user removed the lid above the upper chamber and placed feed smokeable material into the upper chamber. The user also placed a conical-shaped paper wrapper that was sealed on one side and open on the opposite side in the support and attached the support to the lower chamber. The user then activated the motor driving the rotatable blade with the switch. After activation, a portion of the feed smokeable material fell through the grate into the lower chamber.

Once the user believed enough of the feed smokeable material was cut to fall through the grate and fill the wrapper to a desired amount, the user turned off the motor. The cut smokeable material fell through the opening into the wrapper. To compress the fill smokeable material, the user forced the tamper downwardly against the force of the spring biasing means. The user inspected the wrapper for the desired amount of fill smokeable material in the wrapper, and repeated some of the steps until the desired amount of fill smokeable material was contained in the wrapper. In some instances, it was necessary to start up the motor to cut additional feed material.

The user then removed the support from the lower chamber and used the projection on the lid to push the wrapper containing fill smokeable material from the support. The user then closed the opening of the wrapper, forming a cigarette.

Although the present invention has been described in considerable detail with reference to certain preferred embodiments, other embodiments are possible. The steps disclosed for the present methods, for example, are not intended to be limiting nor are they intended to indicate that each step is necessarily essential to the method, but instead are exemplary steps only. Therefore, the scope of the appended claims should not be limited to the description of preferred embodiments contained in this disclosure. All references cited herein are incorporated by reference in their entirety.

The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless each feature disclosed is one example only of a generic series of equivalent or similar features.

What is claimed is:

1. A portable, hand-holdable apparatus for preparing a smokeable product comprising:
a) an enclosing wall providing an upper chamber and a lower chamber;
b) a grate between the chambers;
c) a fill inlet in the wall for placing feed smokeable material into the upper chamber;
d) a door secured to the wall for covering the fill inlet, the door having a closed position for substantially closing the fill inlet and an open position for opening the fill inlet for placement of feed smokeable material into the upper chamber;
e) a feed material cutting mechanism comprising:
i) a size reducer for reducing the size of smokeable material in the upper chamber a sufficient amount that the reduced size smokeable material can pass through the grate into the lower chamber as fill smokeable material;
ii) a motor for rotating the mechanism;
iii) a power source for driving the motor; and
iv) a switch for turning the power source off and on; and
an opening in the lower chamber for fill smokeable material that passes through the grate to pass out of the lower chamber.

2. The apparatus of claim 1 comprising biasing means for biasing the door to the closed position.

3. The apparatus of claim 2 further comprising a lock for locking the door in its open position against the biasing means.

4. The apparatus of claim 1 wherein the door is slidable along the wall.

5. A portable, hand-holdable apparatus for preparing a smokeable product comprising:
a) an elongated wall providing an upper chamber and a lower chamber;
b) a grate between the chambers;
c) a cutting mechanism comprising a size reducer in the upper chamber for reducing the size of feed smokeable material in the upper chamber a sufficient amount that the reduced size smokeable material can pass through the grate into the lower chamber as fill smokeable material, the size reducer being moveable along the longitudinal axis with a first position distal from the grate and a second position closer to the grate;
d) an opening in the lower chamber for fill smokeable material that passes through the grate to pass out of the lower chamber; and
e) biasing means for biasing the size reducer to the second position.

6. The apparatus of claim 5 wherein the size reducer comprises a rotatable grinding plate having first grinding projections, and the grate supports second grinding projections opposed to the first grinding projections for grinding smokeable material between the grinding projections.

7. A portable, hand-holdable apparatus for preparing a smokeable product comprising:
a) an enclosing wall providing an upper chamber and a lower chamber;
b) a grate between the chambers;
c) a fill inlet for placing feed smokeable material into the upper chamber;
d) a cutting mechanism for cutting smokeable material in the upper chamber a sufficient amount such that the cut smokeable material can pass through the grate into the lower chamber to provide fill smokeable material;
e) an opening in the lower chamber for fill smokeable material that passes through the grate to pass into a wrapper; and
f) an elongated storage space supported by the wall for a tamper.

8. The apparatus of claim 7 comprising a removable tamper in the storage space for tamping fill smokeable material in the wrapper.

9. A portable, hand-holdable apparatus for preparing a smokeable product comprising:
a) an enclosing wall providing an upper chamber and a lower chamber;
b) a grate between the chambers;
c) a fill inlet for placing feed smokeable material into the upper chamber;
d) a rotatable cutter in the upper chamber for cutting smokeable material in the upper chamber a sufficient amount such that the cut smokeable material can pass through the grate into the lower chamber to provide fill smokeable material;
e) an opening in the lower chamber for fill smokeable material that passes through the grate to pass into a wrapper; and
f) a mover in the lower chamber for moving fill smokeable material out of the opening.

10. The apparatus of claim 9 comprising a shaft for rotating the cutter.

11. The apparatus of claim 10 wherein the mover is rotatable and the shaft is adapted to rotate the mover.

12. The apparatus of claim 9 wherein the mover is rotatable and the device comprises a shaft adapted for rotating the mover.

13. The apparatus of claim 9 wherein the mover comprises paddles.

14. A method for using the apparatus of claim 9, comprising the steps of:
a) placing feed smokeable material through the fill inlet into the upper chamber; and
b) activating the rotatable cutter for reducing the size of the feed smokeable material, so at least a portion of the feed smokeable material falls through the grate as fill smokeable material into the lower chamber.

15. The method of claim 14 wherein after step b) the fill smokeable material is used to fill a wrapper.

16. A device for preparing a smokeable product comprising:
a) a grinding surface;
b) a rotatable grinder for grinding smokeable material in cooperation with the grinding surface, the grinder being able to rotate both clockwise and counterclockwise;
c) a motor for driving the rotatable grinder for grinding smokeable material between the grinder and the grinding surface;
d) a switch for turning on the motor;
e) a power source for the motor; and
a controller coupled to the motor and adapted to automatically turn off the motor after the grinder has rotated for a predetermined amount of time.

17. The device of claim 16 wherein the predetermined amount of time is from about 3 to about 10 seconds.

18. The device of claim 16 further comprising a detector for detecting the strength of the current provided to the motor and providing an output signal based on the strength detected, and wherein the controller is adapted to turn off the motor when the detected strength exceeds a predetermined amount.

19. The device of claim 16 comprising biasing means for biasing the grinder toward the grinding surface.

20. The device of claim 16 wherein the grinding surface comprises projections.

21. A device for preparing a smokeable product comprising:
a) a grinding surface;
b) a rotatable grinder for grinding smokeable material in cooperation with the grinding surface, the grinder being able to rotate both clockwise and counterclockwise;
c) a motor for driving the rotatable grinder for grinding smokeable material between the grinder and the grinding surface;
d) a switch for turning on the motor;
e) a power source for the motor; and
a controller coupled to the motor and adapted to automatically reverse the direction of rotation of the grinder after the motor is turned on within 5 seconds.

22. The device of claim 21 wherein the controller is adapted to automatically reverse the direction of rotation of the grinder after the motor is turned on within 1 second.

23. The device of claim 21 wherein the controller is adapted to automatically reverse the direction of rotation of the grinder within 0.5 to 3 seconds after the motor is turned on.

24. The device of claim 21 wherein the controller is adapted to automatically reverse the direction of rotation of the grinder at least twice.

25. The device of claim 21 comprising a detector for detecting the strength of the current provided to the motor and providing an output signal based on the strength detected, and wherein the controller is adapted to reverse the direction of rotation of the grinder when the detected strength exceeds a predetermined amount.

26. The device of claim 21 comprising biasing means for biasing the grinder toward the grinding surface.

27. The device of claim 21 wherein the grinding surface comprises projections.

28. A device for preparing a smokeable product comprising:
a) a grinding surface;
b) a rotatable grinder for grinding smokeable material in cooperation with the grinding surface, the grinder being able to rotate both clockwise and counterclockwise;
c) a motor for driving the rotatable grinder for grinding smokeable material between the grinder and the grinding surface;
d) a switch for turning on the motor;
e) a power source for the motor; and
f) a controller coupled to the motor and adapted to automatically reverse the grinder after the grinder has rotated for 1 to 20 rotations.

29. A device for preparing a smokeable product comprising:
a) a grinding surface;
b) a rotatable grinder for grinding smokeable material in cooperation with the grinding surface, the grinder being able to rotate both clockwise and counterclockwise;
c) a motor for driving the rotatable grinder for grinding smokeable material between the grinder and the grinding surface;
d) a switch for turning on the motor;
e) a power source for the motor;
f) a controller coupled to the motor and adapted to automatically turn off the motor after the grinder has rotated for a predetermined amount of time; and
a detector for detecting the strength of current provided to the motor and providing an output signal based on the strength of current detected, and wherein when the controller is adapted to reverse the direction of rotation of the grinder when the detected strength exceeds a predetermined amount.

30. The device of claim 29 wherein the controller is adapted to automatically reverse the motor if the amperage of the motor is between 65 to 90 percent of a predetermined amperage.

31. The device of claim 29 wherein the controller is adapted to automatically reverse the motor if the amperage of the motor is more than 90 percent of a predetermined amperage.

32. A device for preparing a smokeable product comprising:
a) a grinding surface;
b) a rotatable grinder for grinding smokeable material in cooperation with the grinding surface, the grinder being able to rotate both clockwise and counterclockwise;
c) a motor for driving the rotatable grinder for grinding smokeable material between the grinder and the grinding surface;
d) a switch for turning on the motor;
e) a power source for the motor; and
f) a controller that can be adapted for automatically controlling the motor to rotate in a clockwise or counterclockwise direction for rotating the grinder in a clockwise or counterclockwise direction.

33. A device for preparing a smokeable product comprising:
a) a grinding surface;
b) a rotatable grinder for grinding smokeable material n cooperation with the grinding surface;
c) a motor for driving the rotatable grinder for grinding smokeable material between the grinder and the grinding surface;
d) a power source for the motor;
e) at least one opening for discharge of smokeable material ground by the grinder; and
f) a spring for moving the grinder and the grinding surface toward each other as ground smokeable material is discharged through the opening.

34. The device of claim 33 wherein the spring provides 1 to 5 pounds of force.

35. The device of claim 33 wherein the spring biases the grinder towards the grinding surface.

36. The device of claim 33 wherein the spring biases the rotatable grinder in the second position.

37. The device of claim 35 wherein the motor is able to rotate the grinder both clockwise and counterclockwise.

38. The device of claim 35 further comprising a controller coupled to the motor and adapted to automatically reverse the direction of rotation of the rotatable grinder.

39. A device for preparing a smokeable product comprising:
a) a grinding surface;
b) a rotatable grinder for grinding smokeable material in cooperation with the grinding surface;
c) a motor for driving the rotatable grinder for grinding smokeable material between the grinder and the grinding surface;
d) a power source for the motor;
e) at least one opening for discharge of smokeable material ground by the grinder;
f) a spring for moving the grinder and the grinding surface toward each other as ground smokeable material is discharged through the opening; and
g) a controller coupled to the motor and adapted to automatically reverse the direction of the grinder after the grinder has rotated for a predetermined amount of time.

40. A device for comminuting smokeable material comprising:
a) a first rotatable comminution plate having a rotational axis with a plurality of first projections extending from the plate, each of the first projections having a base proximate to the first plate and a side surface, one of the first projections being an axial projection at the rotational axis;
b) a second comminution plate opposed to the first plate, the second plate having a plurality of second projections, the first and second projections oriented so that during a comminution operation wherein the first plate is rotated about the rotational axis, the first and second projections cooperate to comminute smokeable material; and
c) a plurality of cutting blades extending from the side surface of the axial projection.

41. The device of claim 40 wherein the cutting blades extend at an angle of from about 80 degrees to about 10 degrees away from the base of the axial projection relative to the plane of the side surface of the axial projection.

42. The device of claim 41 wherein the cutting blades extend at an angle of about 30 degrees away from the base of the axial projection relative to the plane of the side surface of the axial projection.

43. The device of claim 40 wherein one of the second projections is a central projection with a side surface and a plurality of cutting blades extending from its side surface.
